(19) United States
(12) Patent Application Publication
(10) Pub. No.: US 2026/0170531 A1
(43) Pub. Date: Jun. 18, 2026

(54) LEARNING DEVICE, ESTIMATING DEVICE, LEARNING METHOD, ESTIMATING METHOD, AND PROGRAM

(71) Applicant: RAKUTEN GROUP, INC., Tokyo (JP)

(72) Inventors: Misaki NAGATA, Setagaya-ku, Tokyo (JP); Min CHEN, Setagaya-ku, Tokyo (JP)

(21) Appl. No.: 18/842,432

(22) PCT Filed: Aug. 29, 2023
(86) PCT No.: PCT/JP2023/031284

§ 371 Date: Aug. 29, 2024

(51) Int. Cl. G06Q 30/0242; G06F 40/289; G06F 40/30; G06V 20/40; G06V 40/16

(52) U.S. Cl. CPC G06Q 30/0242; G06F 40/289; G06F 40/30; G06V 20/40; G06V 40/174

(57) ABSTRACT

A learning device, comprising at least one processor configured to, acquire training video information acquired by analyzing a training video advertisement which is a video advertisement for training; acquire training purchase information relating to a purchase by a training viewer who is a viewer of the training video advertisment; and train, based on the training video information and the training purchase information, a machine learning model for estimating an advertising effectiveness of an estimation video advertisement, which is a video advertisement for estimation, from estimation video information acquired by analyzing the estimation video advertisement.

### TECHNICAL FIELD

The present disclosure relates to a learning device, an estimating device, a learning method, an estimating method, and a program.

### BACKGROUND ART

Hitherto, technologies for estimating the advertising effectiveness of a video advertisement have been known. For example, in Patent Literature 1, there is disclosed a method in which behavioral data and physiological data of viewers who have viewed media content such as a video advertisement are processed, a time-series of emotional state data points is obtained, and a classification model that maps between performance data and a predictive parameter of the time-series of emotional state data points outputs predicted performance data indicating performance predicted for the media content. The predictive parameter of Patent Literature 1 is a quantitative index of a relative change in a reaction by the viewer to the video advertisement.

### CITATION LIST

### Patent Literature

[PTL 1] JP 2020-501260 A

### SUMMARY OF INVENTION

### Technical Problem

However, the classification model of Patent Literature 1 outputs the predicted performance data by considering only data which is based on the behavior of the viewer of the video advertisement, and thus the content of the actually distributed video advertisement is not given sufficient consideration in the estimation of the advertising effectiveness of the video advertisement. For this reason, the technology of Patent Literature 1 may not be sufficiently accurate in estimating the advertising effectiveness of video advertisements. This point also applies to related-art technologies other than the technology of Patent Literature 1.

One object of the present disclosure is to improve an accuracy of estimating advertising effectiveness of a video advertisement.

### Solution to Problem

According to one embodiment of the present disclosure, there is provided a learning device including: a training video information acquisition module configured to acquire training video information acquired by analyzing a training video advertisement which is a video advertisement for training; a training purchase information acquisition module configured to acquire training purchase information relating to a purchase by a training viewer who is a viewer of the training video advertisement; and a learning module configured to train, based on the training video information and the training purchase information, a machine learning model for estimating an advertising effectiveness of an estimation video advertisement, which is a video advertisement for estimation, from estimation video information acquired by analyzing the estimation video advertisement.

According to one embodiment of the present disclosure, there is provided an estimating device including: an estimation video information acquisition module configured to acquire estimation video information acquired by analyzing an estimation video advertisement which is a video advertisement for estimation; a model storage unit configured to store a machine learning model trained based on training video information acquired by analyzing a training video advertisement which is a video advertisement for training and training purchase information relating to a purchase by a training viewer who is a viewer of the training video advertisement; and an estimation module configured to estimate an advertising effectiveness of the estimation video advertisement based on the estimation video information and the machine learning model.

### Advantageous Effects of Invention

According to the present disclosure, it is possible to improve the accuracy of estimating the advertising effectiveness of a video advertisement.

### BRIEF DESCRIPTION OF DRAWINGS

FIG. 1 is a diagram for illustrating an example of a hardware configuration of each of a learning device and an estimating device.

FIG. 2 is a diagram for illustrating an example of a training video advertisement distributed by a live distribution service.

FIG. 3 is a diagram for illustrating an example of an outline of each of the learning device and the estimating device.

FIG. 4 is a diagram for illustrating an example of functions implemented by each of the learning device and the estimating device.

FIG. 5 is a table for showing an example of a training database.

FIG. 6 is a table for showing an example of an estimation database.

FIG. 7 is a table for showing an example of a video advertisement database.

FIG. 8 is a flowchart for illustrating an example of processing executed by the learning device.

FIG. 9 is a flowchart for illustrating an example of processing executed in Step S10.

FIG. 10 is a flowchart for illustrating an example of processing executed by the estimating device.

FIG. 11 is a flowchart for illustrating an example of processing executed in Step S20.

FIG. 12 is a diagram for illustrating an example of functions implemented in modification examples of the present disclosure.

### DESCRIPTION OF EMBODIMENTS

### 1. Hardware Configuration of Each of Learning Device and Estimating Device

An example of an embodiment of a learning device, an estimating device, a learning method, an estimating method, and a program according to the present disclosure is now described. In this embodiment, a case in which the learning device and the estimating device are different devices is given as an example, but the learning device and the estimating device may be the same device. That is, a given one device may function as both the learning device and the estimating device.

In this embodiment, the learning device trains a machine learning model for estimating an advertising effectiveness of a video advertisement, which is an advertisement that uses a video. The estimating device performs an estimation based on the trained machine learning model. A video advertisement for training (for learning) used in the training of the machine learning model is hereinafter referred to as “training video advertisement.” A performer in the training video advertisement is referred to as “training performer.” A viewer of the training video advertisement is referred to as “training viewer.” A video advertisement for estimation that is to be processed by the trained machine learning model is referred to as “estimation video advertisement.” A performer in the estimation video advertisement is referred to as “estimation performer.” A viewer of the estimation video advertisement is referred to as “estimation viewer.”

In this embodiment, when the training video advertisement and the estimation video advertisement are not required to be distinguished, the training video advertisement and the estimation video advertisement may simply be referred to as “video advertisement.” When the training performer and the estimation performer are not required to be distinguished, the training performer and the estimation performer may simply be referred to as “performer.” When the training viewer and the estimation viewer are not required to be distinguished, the training viewer and the estimation viewer may simply be referred to as “viewer.” Further, when terms such as “training xxx” and “estimation xxx” are not required to be distinguished, the “training xxx” and the “estimation xxx” may simply be referred to as “xxx.”

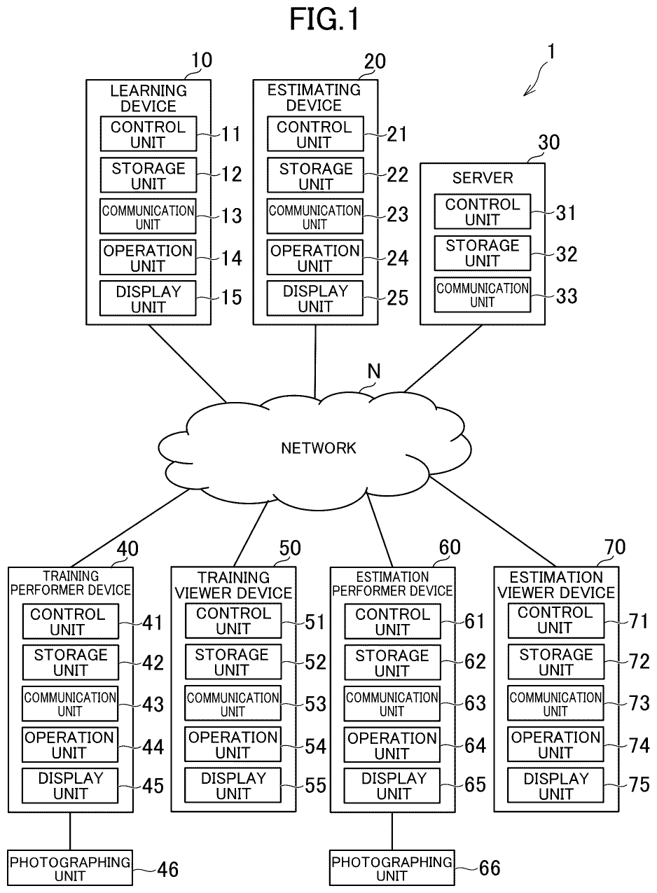

FIG. 1 is a diagram for illustrating an example of the hardware configuration of each of the learning device and the estimating device. In this embodiment, an example of a live distribution system 1 including a learning device 10 and an estimating device 20 is described. In the example of FIG. 1, the live distribution system 1 includes a server 30, training performer device 40, a training viewer device 50, an estimation performer device 60, and an estimation viewer device 70, in addition to the learning device 10 and the estimating device 20. Each of the learning device 10, the estimating device 20, the server 30, the training performer device 40, the training viewer device 50, the estimation performer device 60, and the estimation viewer device 70 is connected to a network N such as the Internet or a LAN.

The learning device 10 is a computer which trains a machine learning model. For example, the learning device 10 is a personal computer, a server computer, a tablet computer, or a smartphone. For example, the learning device 10 includes a control unit 11, a storage unit 12, a communication unit 13, an operation unit 14, and a display unit 15. The control unit 11 includes at least one processor. The storage unit 12 includes at least one of a volatile memory such as a RAM or a nonvolatile memory such as a flash memory. The communication unit 13 includes at least one of a communication interface for wired communication or a communication interface for wireless communication. The operation unit 14 is an input device such as a touch panel. The display unit 15 is a liquid crystal or organic EL display.

The estimating device 20 is a computer which performs an estimation based on the trained machine learning model. For example, the estimating device 20 is a personal computer, a server computer, a tablet computer, or a smartphone. For example, the estimating device 20 includes a control unit 21, a storage unit 22, a communication unit 23, an operation unit 24, and a display unit 25. The hardware configurations of the control unit 21, the storage unit 22, the communication unit 23, the operation unit 24, and the display unit 25 may be the same as the hardware configurations of the control unit 11, the storage unit 12, the communication unit 13, the operation unit 14, and the display unit 15, respectively.

The server 30 is a server computer managed by an operator of a live distribution service which distributes videos in real time to an unspecified number of people. In this embodiment, a case in which the operator of the live distribution service also manages the learning device 10 and the estimating device 20 is given as an example, but another party may manage the learning device 10 and the estimating device 20. For example, the server 30 includes a control unit 31, a storage unit 32, and a communication unit 33. The hardware configurations of the control unit 31, the storage unit 32, and the communication unit 33 may be the same as the hardware configurations of the control unit 11, the storage unit 12, and the communication unit 13, respectively.

The training performer device 40 is a computer of the training performer. For example, the training performer device 40 is a personal computer, a tablet computer, or smartphone. For example, the training performer device 40 includes a control unit 41, a storage unit 42, a communication unit 43, an operation unit 44, and a display unit 45. The hardware configuration of the control unit 41, the storage unit 42, the communication unit 43, the operation unit 44, and the display unit 45 may be the same as the hardware configurations of the control unit 11, the storage unit 12, the communication unit 13, the operation unit 14, and the display unit 15, respectively. A photographing unit 46 is connected to the training performer device 40. The photographing unit 46 includes at least one camera. The photographing unit 46 may be included inside the training performer device 40.

The training viewer device 50 is a computer of the training viewer. For example, the training viewer device 50 is a personal computer, a tablet computer, or a smartphone. For example, the training viewer device 50 includes a control unit 51, a storage unit 52, a communication unit 53, an operation unit 54, and a display unit 55. The hardware configurations of the control unit 51, the storage unit 52, the communication unit 53, the operation unit 54, and the display unit 55 may be the same as the hardware configurations of the control unit 11, the storage unit 12, the communication unit 13, the operation unit 14, and the display unit 15, respectively.

The estimation performer device 60 is a computer of the estimation performer. For example, the estimation performer device 60 is a personal computer, a tablet computer, or a smartphone. For example, the estimation performer device 60 includes a control unit 61, a storage unit 62, a communication unit 63, an operation unit 64, and a display unit 65, and is connected to a photographing unit 66. The hardware configurations of the control unit 61, the storage unit 62, the communication unit 63, the operation unit 64, the display unit 65, and the photographing unit 66 may be the same as the hardware configurations of the control unit 11, the storage unit 12, the communication unit 13, the operation unit 14, the display unit 15, and the photographing unit 46, respectively. The photographing unit 66 may be included inside the estimation performer device 60.

The estimation viewer device 70 is a computer of the estimation performer. For example, the estimation viewer device 70 is a personal computer, a tablet computer, or a smartphone. For example, the estimation viewer device 70 includes a control unit 71, a storage unit 72, a communication unit 73, an operation unit 74, and a display unit 75. The hardware configurations of the control unit 71, the storage unit 72, the communication unit 73, the operation unit 74, and the display unit 75 may be the same as the hardware configurations of the control unit 11, the storage unit 12, the communication unit 13, the operation unit 14, and the display unit 15, respectively.

The programs stored in the storage units 12, 22, 32, 42, 52, 62, and 72 may be supplied via the network N to the learning device 10, the estimating device 20, the server 30, the training performer device 40, the training viewer device 50, the estimation performer device 60, or the estimation viewer device 70. Further, a program stored in a computer-readable information storage medium may be supplied to the learning device 10, the estimating device 20, the server 30, the training performer device 40, the training viewer device 50, the estimation performer device 60, or the estimation viewer device 70 via a reading unit (for example, an optical disc drive or a memory card slot) for reading an information storage medium, or an input/output unit (for example, a USB port) for inputting and outputting data to and from an external device.

It suffices that the live distribution system 1 includes at least one computer, and the live distribution system 1 is not limited to the example of FIG. 1. For example, the live distribution system 1 includes the learning device 10, the estimating device 20, and the server 30, and is not required to include the training performer device 40, the training viewer device 50, the estimation performer device 60, and the estimation viewer device 70. In this case, the training performer device 40, the training viewer device 50, the estimation performer device 60, and the estimation viewer device 70 exist outside the live distribution system 1. In addition, for example, the learning device 10 and the estimating device 20 are not included in the live distribution system 1, and may exist outside the live distribution system 1.

### 2. Outline of Each of Learning Device and Estimating Device

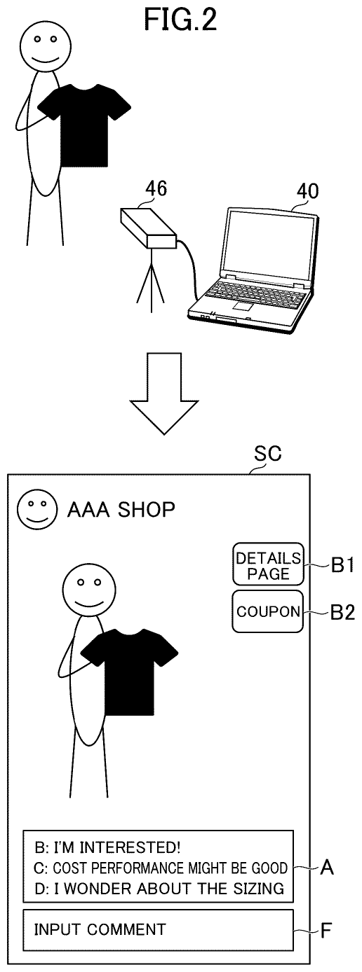

FIG. 2 is a diagram for illustrating an example of a training video advertisement distributed by the live distribution service. For example, the training performer advertises a product or a service to be commercially traded by electronic commerce in front of the photographing unit 46. The training performer device 40 transmits a training video advertisement generated by the photographing unit 46 to the server 30. The server 30 distributes, in real time, the training video advertisement received from the training performer device 40 to the training viewer devices 50 of an unspecified number of training viewers. A screen SC showing a training video advertisement is displayed on the display unit 55 of the training viewer devices 50.

For example, when the training viewer selects a button B1, the training viewer device 50 accesses a page showing details of the product or service introduced by the training video advertisement. The training viewer can purchase the product or the service from the page. The details may be displayed on the screen SC. When the training viewer selects a button B2, the training viewer device 50 accesses a page showing a coupon for the product or the service introduced by the training video advertisement. The training viewer can acquire the coupon for the product on the page. The coupon may also be acquired on the screen SC.

For example, the training viewer can input a comment regarding the training video advertisement into an input form F. Comments input by each of the training viewer and other training viewers are displayed in a display area A of the screen Sc. One of the goals of a live distribution service like that mentioned above is to maximize advertising effectiveness. Advertising effectiveness can also be referred to as “conversion rate.” For example, advertising effectiveness may be expressed as the number of sales of the product or the service, the sales revenue, the number of additions to shopping carts, the number of additions to bookmarks, the number of users who have added the store to their favorites list from the video advertisement page, or a combination of those. Advertising effectiveness is considered to be influenced by various factors. In this embodiment, the learning device 10 trains a machine learning model for estimating advertising effectiveness in the live distribution service. The estimating device 20 uses the trained machine learning model to perform an estimation.

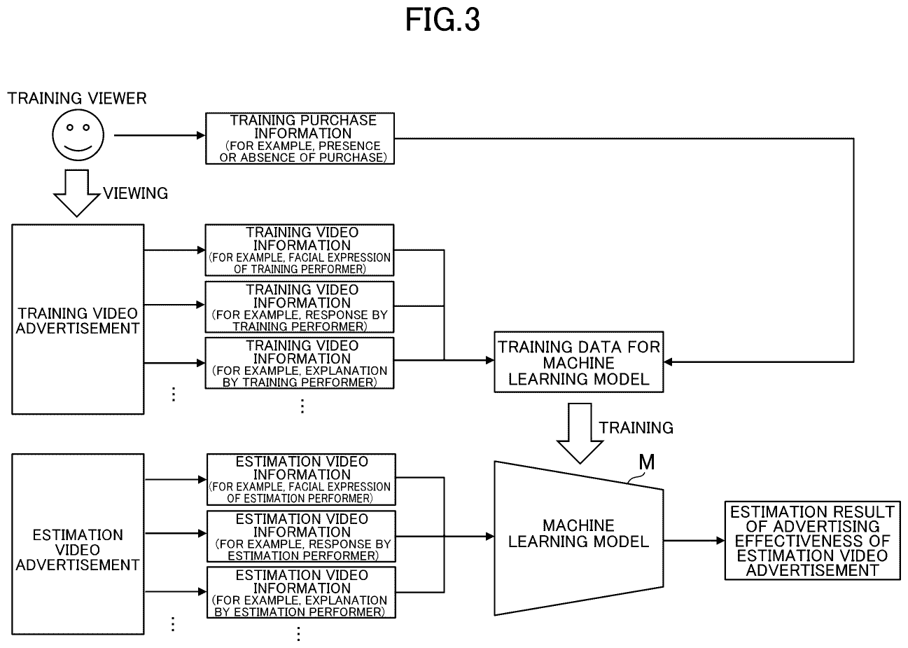

FIG. 3 is a diagram for illustrating an example of an outline of each of the learning device 10 and the estimating device 20. In this embodiment, the learning device 10 acquires training video information indicating a feature of the training video advertisement by executing various types of analysis on the distributed training video advertisement. The training video information indicates a feature considered to have a causal relationship with the advertising effectiveness of the training video advertisement. Details of the method of acquiring the training video information are described later, but for example, the learning device 10 analyzes a facial expression of the training performer, a response by the training performer, and an explanation by the training performer, and acquires a plurality of pieces of training video information.

In this embodiment, the learning device 10 acquires training viewer information on purchases by the training viewer by tracking the behavior of the training viewer. The training viewer information corresponds to an index indicating the advertising effectiveness of the training video advertisement. Details of the method of acquiring training purchase information are described later, but the training viewer information is acquired by, for example, tracking the presence or absence of a purchase by the training viewer. In FIG. 3, one piece of training viewer information is illustrated, but the learning device 10 may acquire a plurality of pieces of training viewer information.

In the example of FIG. 3, the learning device 10 generates training data for the machine learning model M to learn based on a plurality of pieces of training video information and one piece of training viewer information. Details of the training data are also described later. For example, the learning device 10 may execute the same processing on each of a plurality of training video advertisements to generate training data one after another. The learning device 10 trains the machine learning model M based on the training data. Details of the training are also described later. The learning device 10 transmits the trained machine learning model M to the estimating device 20. The estimating device 20 records the trained machine learning model M received from the learning device 10 in the storage unit 22.

For example, in order to provide ex post facto analysis of the advertising effectiveness of an estimation video advertisement that has already been distributed, the estimating device 20 acquires estimation video information by executing various types of analysis on the estimation video advertisement. In this embodiment, the estimation video advertisement is distributed based on the same flow as that of the training video advertisement described with reference to FIG. 2. For example, the estimation performer operates the estimation performer device 60, takes a photograph of himself or herself with the photographing unit 66, and introduces a product or a service. The server 30 distributes the estimation video advertisement to the estimation viewer devices 70 of an unspecified number of estimation viewers. Details of the estimation video information are described later, but the method of acquiring the estimation video information may be the same as the method of acquiring the training video information.

For example, the estimating device 20 inputs a plurality of pieces of estimation video information to the machine learning model M. The machine learning model M calculates a feature amount (embedded expression) based on the plurality of pieces estimation video information. The machine learning model M estimates the advertising effectiveness of the estimation video advertisement based on the feature amount. For example, the machine learning model M estimates a probability of an estimation viewer who views the estimation video advertisement purchasing the product or the service.

For example, the estimating device 20 acquires the estimation result output from the machine learning model M. The estimating device 20 can use the estimation result of the machine learning model M for any purpose. For example, the estimating device 20 may display the estimation result of the machine learning model M on the display unit 25. The estimating device 20 may transmit the estimation result of the machine learning model M to the estimation performer device 60 in order to provide feedback on the advertising effectiveness of the estimation video advertisement to the estimation performer.

As described above, the learning device 10 of this embodiment creates a machine learning model M which estimates advertising effectiveness highly accurately by training the machine learning model M based on the training video information and training purchase information. The estimating device 20 can accurately estimate the advertising effectiveness of the estimation video advertisement by performing an estimation based on the machine learning model M trained by the learning device 10. Details of this embodiment are now described.

### 3. Functions Implemented by Each of Learning Device and Estimating Device

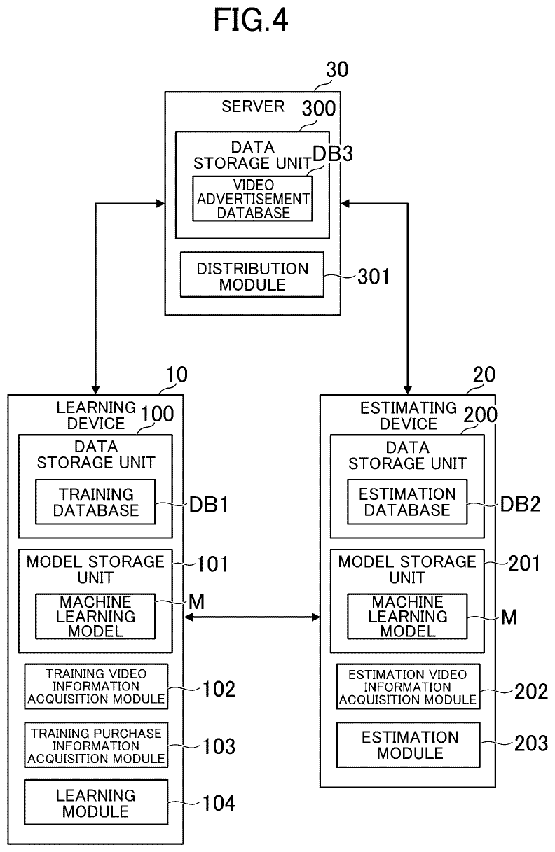

FIG. 4 is a diagram for illustrating an example of functions implemented by each of the learning device 10 and the estimating device 20. In FIG. 4, functions implemented by the server 30 are also illustrated.

### 3-1. Functions Implemented by Learning Device

For example, the learning device 10 includes a data storage unit 100, a model storage unit 101, a training video information acquisition module 102, a training purchase information acquisition module 103, and a learning module 104. The data storage unit 100 and the model storage unit 101 are implemented by the storage unit 12. The training video information acquisition module 102, the training purchase information acquisition module 103, and the learning module 104 are implemented by the control unit 11.

### Data Storage Unit

The data storage unit 100 stores data required for training the machine learning model M. For example, the data storage unit 100 stores a training database DB1.

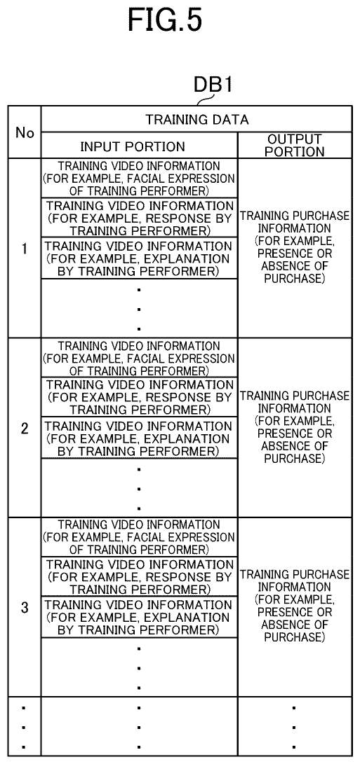

FIG. 5 is a table for showing an example of the training database DB1. The training database DB1 is a database which stores training data to be learned by the machine learning model M. In this embodiment, each unit of data used during the learning by the machine learning model M is referred to as “training data.” A collection of training data in which a plurality of pieces of training data are stored is referred to as “training database DB1.” All or some of the plurality of pieces of training data stored in the training database DB1 is learned by the machine learning model M.

In the example of FIG. 5, “No” is the record number in the training database DB1. In this embodiment, a case in which one piece of training data is generated from one training video advertisement is given as an example. That is, the training video advertisement and the training data have a one-to-one relationship. Thus, “No” of FIG. 5 can also be said to be information that can identify the training video advertisement. It is noted that a plurality of pieces of training data may be generated from one training video advertisement, or one piece of training data may be generated from a plurality of training video advertisements.

For example, the training data includes an input portion which is input to the machine learning model M during training, and an output portion to be output from the machine learning model M during training. The input portion of the training data has the same format as that of the input data input to the machine learning model M during estimation. The input portion of the training data is sometimes referred to as an explanatory variable. In this embodiment, the input portion of the training data is a plurality of pieces of training video information. The output portion of 41 the training data has the same format as that of the output data output from the machine learning model M during estimation. The output portion of the training data corresponds to a ground truth during training. The output portion of the training data is sometimes referred to as an objective variable. In this embodiment, a case in which the output portion of the training data is training purchase information is given as an example.

The data storage unit 100 can store any data. The data stored by the data storage unit 100 is not limited to the training database DB1. For example, the data storage unit 100 may store a learning program showing a series of processes to be performed in the training of the machine learning model M. The data storage unit 100 may store video data of a training video advertisement downloaded by the learning device 10 from the server 30. The data storage unit 100 may store data supplementary to the video data of the training video advertisement (for example, category, pre-entered explanatory text, coupon information, or combination of those, of the product or the service introduced in the training video advertisement).

For example, the data storage unit 100 may store a natural language processing program, which is described later. The data storage unit 100 may store a dictionary database in which keywords used in natural language processing are stored. The data storage unit 100 may store a machine learning model M for natural language processing. The data storage unit 100 may store an image analysis processing program, which is described later. The data storage unit 100 may store a machine learning model M for image analysis processing.

### Model Storage Unit

The model storage unit 101 stores the machine learning model M. The machine learning model M includes a program portion showing processing such as calculating the feature amount (embedded expression) of the input data input to the machine learning model M, and a parameter portion (for example, a weighting coefficient and a bias) to be referred to by the program portion. The parameter portion of the machine learning model M is changed by the training by the learning module 104. The model storage unit 101 stores a machine learning model M in which the parameter portion is an initial value. A machine learning model M in which the parameter portion has an initial value is a machine learning model M before training. The parameter portion having the initial value is overwritten by the processing by the learning module 104.

The machine learning model M is a model which uses a machine learning method. For the machine learning itself, various publicly-known methods can be used. For example, the machine learning model M may be a model which uses any of supervised learning, semi-supervised learning, or unsupervised learning. In this embodiment, a case in which the machine learning model M is a neural network is given as an example, but the machine learning model M may be a model which uses another method, and is not limited to a neural network. For example, the machine learning model M may be a model which uses linear regression, a model which uses logistic regression, a model which uses a support vector machine, or a model which uses a decision tree.

### Training Video Information Acquisition Module

The training video information acquisition module 102 acquires the training video information acquired by analyzing a training video advertisement, which is a video advertisement for training. In this embodiment, a case in which a video advertisement that has been distributed in the past corresponds to the training video advertisement is given as an example, but an undistributed video advertisement may correspond to the training video advertisement. Further, a case in which a video of a live distribution service corresponds to the training video advertisement is given as an example, but the training video advertisement may be any video advertisement used for learning, and is not limited to a video of a live distribution service. For example, an online advertisement, a television advertisement, an outdoor advertisement, a movie advertisement, or another advertisement may correspond to the training video advertisement.

The analysis of the training video advertisement is processing for extracting a feature relating to the training video advertisement. For example, speech analysis processing, natural language processing, image analysis processing, or a combination of those corresponds to the analysis of the training video advertisement. The training video information indicates the feature extracted by the analysis of the training video advertisement. An example of the feature acquired as the training video information by the training video information acquisition module 102 is now described. As the training video information, it suffices that the training video information acquisition module 102 acquires a feature which the party who creates the machine learning model M (for example, the operator of the live distribution service) considers to have some kind of causal relationship with advertising effectiveness. The feature acquired by the training video information acquisition module 102 as training video information is not limited to the example of this embodiment.

In this embodiment, the training video information acquisition module 102 acquires the training video information acquired by executing natural language processing on a training text acquired by analyzing speech in the training video advertisement. For example, the speech in the training video advertisement is speech uttered by the training performer. The speech in the training video advertisement may be any speech included in the training video advertisement, and is not limited to speech uttered by the training performer. For example, the speech in the training video advertisement may be speech uttered by a staff member other than the training performer, a spectator viewing the training video advertisement on site, a third party interviewed by the training performer, or may be artificial speech prepared in advance.

The training text is a text generated from the speech in the training video advertisement. For example, the training video information acquisition module 102 generates the training text by executing speech analysis processing on the speech in the training video advertisement. The speech analysis processing algorithm itself may be a publicly-known algorithm. For example, the training information acquisition module generates the training text from the speech in the training video advertisement based on a method which uses a hidden Markov model, a method which uses a predetermined waveform pattern, a machine learning method such as a neural network, or another method. The training text may be generated by a computer other than the learning device 10. In this case, the training text generated by the other computer is acquired by the training video information acquisition module 102 from the other computer, from another computer, or from an information storage medium.

For example, the training video information acquisition module 102 acquires the training video information by executing natural language processing on the training text. Natural language processing is processing that allows computers to recognize languages used by humans. The natural language processing may be executed by a computer other than the learning device 10. In this case, the training text generated by natural language processing executed by the other computer is acquired by the training video information acquisition module 102 from the other computer, from another computer, or from an information storage medium.

For example, the natural language processing may be at least one of sentiment analysis processing for analyzing an emotion of a training performer who is a performer in the training video advertisement, response detection processing for detecting a response by a training performer who is a performer in the training video advertisement, explanation detection processing for detecting an explanation relating to a product or a service introduced in the training video advertisement, or promotion detection processing for detecting a promotion relating to the training video advertisement.

For example, the training video information acquisition module 102 acquires the training video information relating to the emotions of the training performer by executing sentiment analysis processing on the training text. The sentiment analysis processing method may be a publicly-known method. For example, the training video information acquisition module 102 may analyze the emotions of the training performer based on a rule approach of determining Whether or not a keyword indicating an emotion is included in the training text. For example, the training video information acquisition module 102 may analyze the emotions of the training performer based on a machine learning approach of calculating a feature amount of the training text and outputting a result of classifying the emotions.

For example, the training video information acquisition module 102 acquires the training video information indicating the analysis result of the emotions of the training performer through sentiment analysis processing. In a case in which a range of emotions such as happiness, anger, sadness, and pleasure is analyzed, the training video information acquisition module 102 acquires the training video information indicating the level of the emotion of “happiness” (for example, the number of times or frequency of appearance of a keyword indicating “happiness”), the level of the emotion of “anger” (for example, the number of times or frequency of appearance of a keyword indicating “anger”), the level of the emotion of “sadness” (for example, the number of times or frequency of appearance of a keyword indicating “sadness”), and the level of the emotion of “pleasure” (for example, the number of times or frequency of appearance of a keyword indicating “pleasure”). The training video information acquisition module 102 may analyze emotions other than happiness, anger, sadness, and pleasure.

For example, the training video information acquisition module 102 acquires the training video information relating to a response by the training performer by executing response detection processing on the training text. The response detection processing method may be a publicly-known method. For example, the training video information acquisition module 102 may detect the response by the training performer based on a rule approach of determining whether or not a keyword indicating the response is included in the training text. For example, the training video information acquisition module 102 may detect the response by the training performer based on a machine learning approach of calculating a feature amount of the training text and outputting a result of classifying the response.

The response detected by response detection processing can also be referred to as “reaction.” The response detected by the response detection processing may be a response by a certain training performer to a statement by another training performer. The response in this case can also be said to be an interaction between training performers. The training video information acquisition module 102 acquires the training video information indicating a detection result of the response by the training performer through response detection processing. For example, the training video information acquisition module 102 detects a response from a certain training performer to a statement by another certain training performer when the training text includes a statement such as “I see.”

As another example, the response detected by the response detection processing may be the response by a training performer to a comment input by a training viewer. The training video information acquisition module 102 detects the response by the training performer to the comment input by the training viewer when the training text includes a statement such as “Thank you for your comment.” The training video information acquisition module 102 may acquire training video information indicating the number of responses detected by the response detection processing, the frequency of responses, the types of responses (for example, what the response is responding to, or the specific content of the response), or a combination of those.

For example, the training video information acquisition module 102 acquires the training video information relating to an explanation by the training performer by executing explanation detection processing on the training text. The explanation detection processing method may be a publicly-known method. For example, the training video information acquisition module 102 may detect the response by the training performer based on a rule approach of determining whether or not a keyword indicating an explanation of the product or the service is included in the training text. For example, the training video information acquisition module 102 may detect an explanation by the training performer based on a machine learning approach of calculating a feature amount of the training text and outputting a result of classifying the explanation of the product or the service.

For example, the training video information acquisition module 102 acquires the training video information indicating the detection result of the explanation by the training performer through explanation detection processing. In a case in which a sweet is introduced in a training video advertisement, the training video information acquisition module 102 counts the number of times or frequency of appearance of a keyword indicating the product itself, such as “chocolate,” in the training text. The training video information acquisition module 102 counts the number of times or frequency of appearance of a keyword indicating the quality of the product, such as “delicious,” in the training text. The training video information acquisition module 102 acquires the training video information indicating those count results.

For example, the promotion detection processing may be keyword detection processing for detecting at least one of a keyword relating to a price of the product or the service introduced in the training video advertisement, a keyword relating to a sales trend of the product or the service introduced in the training video advertisement, or a keyword relating to an explanation associated with the training video advertisement. Promotion detection processing can also be referred to as processing for detecting words that lead to promotion of the product or the service. The training video information acquisition module 102 may detect the response by the training performer based on a rule approach of determining whether or not the training text includes a keyword indicating the price of the product or the service.

For example, the training video information acquisition module 102 determines whether or not the training text includes a keyword stored in a dictionary database in which price-related keywords (for example, “1,000 yen,” “bargain,” “discount,” or “coupon”) are stored, and detects the keyword. The training video information acquisition module 102 determines whether or not the training text includes a keyword stored in a dictionary database in which keywords relating to the sales trend (for example, “sold”or “only a few left”) are stored, and detects the keyword.

An explanation associated with the training video advertisement is an explanation of the product or the service introduced in the training video advertisement. For example, information that the training viewer can appropriately refer to from the screen SC may correspond to an explanation associated with the training video advertisement. In the example of FIG. 2, a detailed explanation that the training viewer can refer to by selecting the button B1 is an example of an explanation associated with the training video advertisement. Coupon information that the training viewer can refer to by selecting the button B2 is an example of an explanation associated with the training video advertisement.

For example, the training video information acquisition module 102 determines whether or not the training text includes a keyword stored in a dictionary database in which keywords in the explanation (for example, “limited time,” “delicious,” or “hot topic”) relating to the product or the service introduced in the training video advertisement are stored, and detects the keyword. The training video information acquisition module 102 acquires the training video information indicating the number of keyword detections or the detection frequency based on the result of keyword detection as described above.

The promotion detection processing is not limited to the above-mentioned examples. For example, instead of a rule approach using a keyword, the training video information acquisition module 102 may detect a promotion based on a machine learning approach of calculating a feature amount of the training text and outputting a promotion estimation result. It is assumed that the model used in the machine learning approach has been trained by using various words that can be used to promote the product or the service.

The training video information acquisition module 102 can execute any natural language processing on the training text. The natural language processing executed by the training video information acquisition module 102 is not limited to the examples of this embodiment. For example, the training video information acquisition module 102 may execute morphological analysis, syntactic analysis, semantic analysis, feature amount extraction, or a combination of those as the natural language processing performed on the training text, and acquire training video information based on the execution result of the natural language processing. The training video information acquisition module 102 may execute natural language processing by using a machine learning method such as a transformer on the training text.

For example, the training video information acquisition module 102 may acquire the training video information relating to a facial expression of a training performer, who is a performer in the training video advertisement, which is acquired by analyzing a video of the training video advertisement. The video of the training video advertisement includes a plurality of frames (still images). The training video information acquisition module 102 acquires the training video information by executing image analysis processing on each frame. The image analysis processing may be executed by a computer other than the learning device 10. In this case, the training video information generated by image analysis processing executed by the other computer is acquired by the training video information acquisition module 102 from the other computer, from another computer, or from an information storage medium.

The facial expression of the training performer can also be said to express the emotions of the training performer. For this reason, the training video information acquisition module 102 may use image analysis processing to identify similar emotions to those in the sentiment analysis processing. The method of analyzing human facial expressions by image analysis processing may be a publicly-known method. For example, the training video information acquisition module 102 may analyze the facial expression of the training performer in the training video advertisement based on template matching using template images showing basic human facial expressions. The training video information acquisition module 102 may analyze the facial expression of the training performer in the training video advertisement based on an arrangement pattern of feature points detected from the video of the training video advertisement. The training video information acquisition module 102 may analyze the facial expression of the training performer in the training video advertisement based on a machine learning model in which various human facial expressions have been learned.

The training video information acquisition module 102 may use image analysis processing to analyze features other than the facial expression of the training performer. For example, the training video information acquisition module 102 may use image analysis processing to analyze the camera work, brightness of lighting, gestures of the training performer, special effects in the video, content of subtitles, or other features in the training video advertisement. The training video information acquisition module 102 may acquire training video information indicating those features.

Further, in this embodiment, a case in which the training video information acquisition module 102 acquires a plurality of pieces of training video information is given as an example, but it suffices that the training video information acquisition module 102 acquires at least one piece of training video information. The training video information acquisition module 102 may acquire only one piece of training video information. For example, the training video information acquisition module 102 may execute only one of the methods described above, and acquire only one piece of training video information.

### Training Purchase Information Acquisition Module

The training purchase information acquisition module 103 acquires training purchase information relating to a purchase by the training viewer, who is a viewer of the training video advertisement. A purchase by the training viewer is the purchase of the product or the service introduced in the training video advertisement. The training viewer may make a purchase while viewing the training video advertisement, or may make a purchase after viewing the training video advertisement. The training viewer may make a purchase by viewing an archived training video advertisement after the live distribution has ended, instead of during the live distribution of the training video advertisement.

In the example of FIG. 2, the training viewer may select the button B1 on the screen SC and then make a purchase from the page displayed on the training viewer device 50, or may make a purchase by performing an operation other than selecting the button B1. For example, the training viewer may first close the screen SC, select a link to the page of the product or the service introduced in the training video advertisement, and then make a purchase from the page displayed on the training viewer device 50.

In this embodiment, a distribution module 301 of the server 30 tracks the behavior of the training viewer and generates training purchase information. The training purchase information acquisition module 103 acquires the training purchase information from the server 30. The training purchase information may be generated by a computer other than the server 30. The training purchase information acquisition module 103 may acquire the training purchase information from the other computer, from another computer, or from an information storage medium. The training purchase information acquisition module 103 may acquire the training purchase information by generating the training purchase information itself.

In this embodiment, a case in which the training purchase information acquisition module 103 acquires training purchase information indicating the percentage of training viewers who make a purchase among the training viewers who view the training video advertisement (total number of training viewers who make a purchase/total number of training viewers) is given as an example. The training purchase information may be any information relating to the purchase by the training viewer, and is not limited to the example of this embodiment. For example, the training purchase information acquisition module 103 may acquire training purchase information relating to at least one of a presence or absence of a purchase by the training viewer or information relating to sales of the product or the service introduced in the training video advertisement.

The Training Purchase information relating to the presence or absence of a purchase is information generated based on the presence or absence of a purchase by the training viewer. The above-mentioned “percentage” is also an example of training purchase information relating to the presence or absence of a purchase, but the training purchase information relating to the presence or absence of a purchase may be other information. For example, the training purchase information relating to the presence or absence of a purchase may be information indicating the presence or absence of a purchase by each training viewer, the total number of training viewers who make a purchase, the total number of those people per unit time, or a combination of those. The unit time may be any length, and may be, for example, 1 minute or 5 minutes. For example, the server 30 generates the training purchase information by aggregating those pieces of information.

The information relating to the sales of the product or the service introduced in the training video advertisement is information generated based on the sales of the product or the service. For example, the information relating to the sales may be the number of sales (number sold) of the product or the service, the sales amount, the number of sales per unit time, the sales amount per unit time, or a combination of those. For example, the server 30 generates the training purchase information by aggregating those pieces of information.

### Learning Module

The learning module 104 trains, based on the training video information and the training purchase information, the machine learning model M for estimating the advertising effectiveness of an estimation video advertisement from estimation video information acquired by analyzing the estimation video advertisement, which is a video advertisement for estimation. The learning module 104 generates training data based on the training video information and the training purchase information. In this embodiment, the learning module 104 generates the training data such that the training video information becomes the input portion of the training data and the training purchase information becomes the output portion of the training data.

Instead of directly using the training video information as the input portion of the training data, the learning module 104 may execute some sort of processing such as normalization or aggregation processing on the training video information, and use the processed training video information as the input portion of the training data. Similarly, instead of directly using the training purchase information as the output portion of the training data, the learning module 104 may execute some sort of processing such as normalization or aggregation processing on the training purchase information, and use the processed training purchase information as the output portion of the training data.

For example, the learning module 104 trains the machine learning model M based on the training data. In this embodiment, the learning module 104 generates pieces of training data one after another based on each of a plurality of training video advertisements, and stores the generated training data in the training database DB1. The learning module 104 trains the machine learning model M based on all or some the plurality of pieces of training data stored in the training database DB1. Some of the pieces of training data may be used for verifying the trained machine learning model M. The learning module 104 may generate the training data based on only one training video advertisement instead of a plurality of training video advertisements.

The training is processing for adjusting the parameter portion of the machine learning model M. The learning method may be a publicly-known method used in publicly-known machine learning. For example, the learning module 104 trains the machine learning model M based on a learning method such as error backpropagation or gradient descent so that when the input portion of the training data is input, the output portion of the training data is output. The learning module 104 calculates a loss based on a publicly-known loss function, and performs training until the loss becomes small to a certain extent. The learning module 104 may end the training when training has been performed based on a certain fixed number of pieces of training data.

For example, when the training video information is acquired by executing natural language processing on a training text, similar data is input to the machine learning model M at the time of estimation. For this reason, the learning module 104 trains the machine learning model M for estimating the advertising effectiveness from the estimation video information acquired by executing processing similar to the natural language processing performed on the training text on estimation text acquired by analyzing the speech in the estimation video advertisement.

The estimation text is a text generated from the speech in the estimation video advertisement. In this embodiment, the processing performed during estimation is executed by the estimating device 20, and thus the generation of the estimation text is executed by the estimating device 20. The method of generating the estimation text may be the same as the method of generating the training text. For details of the method of generating the estimation text, “training” in the description of the method of generating the training text can be read as “estimation.” For the natural language processing performed on the estimation text as well, “training” in the description of the natural language processing performed on the training text can be read as “estimation.”

For example, when training video information is acquired by analyzing a video of a training video advertisement, the same data is input to the machine learning model M during estimation. For this reason, the learning module 104 trains the machine learning model M for estimating the advertising effectiveness based on the estimation video information relating to the facial expression of the estimation performer, who is a performer in the estimation video advertisement, acquired by analyzing the video of the estimation video advertisement.

The facial expression of the estimation performer is a facial expression identified by analysis of the video of the estimation video advertisement. In this embodiment, the processing performed during estimation is executed by the estimating device 20, and thus the analysis of the facial expression of the estimation performer is executed by the estimating device 20. The method of analyzing the facial expression of the estimation performer may be the same as the method of analyzing the facial expression of the training performer. For details of the method of analyzing the facial expression of the training performer, “training” in the description of the method of analyzing the facial expression of the training performer can be read as “estimation.”

For example, when at least one of the presence or absence of a purchase by the estimation viewer, who is a viewer the estimation video advertisement, or information relating to the sales of the product or the service introduced in the estimation video advertisement is acquired as the training purchase information, the learning module 104 trains the machine learning model M for estimating the at least one of those pieces of training purchase information as the advertising effectiveness. The learning module 104 acquires the output portion of the training data based on the at least one of those pieces of training purchase information. The training method based on the training data is as described above.

### 3-2. Functions Implemented by Estimating Device

For example, the estimating device 20 includes a data storage unit 200, a model storage unit 201, an estimation video information acquisition module 202, and an estimation module 203. The data storage unit 200 and the model storage unit 201 are implemented by the storage unit 22. The estimation video information acquisition module 202 and the estimation module 203 are implemented by the control unit 21.

### Data Storage Unit

The data storage unit 200 stores data required for estimation based on the machine learning model M. For example, the data storage unit 200 stores an estimation database DB2.

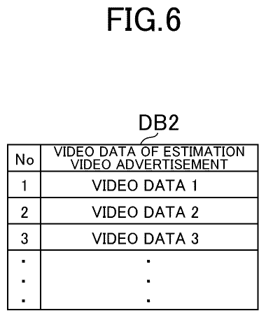

FIG. 6 is a table for showing an example of the estimation database DB2. The estimation database DB2 is a database which stores data relating to an estimation video advertisement that the machine learning model M uses to estimate advertising effectiveness. In this embodiment, a case in which the estimation database DB2 stores the video data of each of a plurality of estimation video advertisements is given as an example, but the estimation database DB2 may store estimation video information generated from each of a plurality of estimation video advertisements by the estimation video information acquisition module 202. The estimation database DB2 may also store data indicating the advertising effectiveness estimated for the estimation video advertisement. As used herein, the term “video data” also includes “speech information.”

For example, the estimating device 20 downloads the video data of all or some of video advertisements stored in a video advertisement database DB3, which is described later, from the server 30 as the video data of the estimation video advertisement. The estimating device 20 stores the downloaded video data in the estimation database DB2. The estimating device 20 may acquire the video data of the estimation video advertisement from a computer other than the server 30 or from an information storage medium.

The data storage unit 200 can store any data. The data stored by the data storage unit 200 is not limited to the estimation database DB2. For example, the data storage unit 200 may store data supplementary to the video data of the estimation video advertisement (for example, category, pre-entered explanatory text, coupon information, or combination of those, of the product or the service introduced in the estimation video advertisement).

For example, the data storage unit 200 may store a natural language processing program. The data storage unit 200 may store a dictionary database in which keywords used in natural language processing are stored. The data storage unit 200 may store a machine learning model M for natural language processing. The data storage unit 200 may store an image analysis processing program. The data storage unit 200 may store a machine learning model M for image analysis processing.

### Model Storage Unit

The model storage unit 201 stores the machine learning model M which has been trained based on the training video information acquired by analyzing the training video advertisement, which is a video advertisement for training, and the training purchase information relating to the purchase by the training viewer, who is a viewer of the training video advertisement. The estimating device 20 acquires the machine learning model M trained by the learning module 104 from the learning device 10. The estimating device 20 records the machine learning model M acquired from the learning device 10 in the model storage unit 201.

### Estimation Video Information Acquisition Module

The estimation video information acquisition module 202 acquires the estimation video information acquired by analyzing the estimation video advertisement, which is a video advertisement for estimation. For example, the estimation video information acquisition module 202 acquires the estimation video information on all or some of estimation video advertisements for which video data is stored in the estimation database DB2. The estimation video advertisement for which estimation video information is acquired by the estimation video information acquisition module 202 may be specified by the person operating the estimating device 20, or may be determined by a method determined in advance.

In this embodiment, a case in which a video advertisement that has been distributed in the past corresponds to the estimation video advertisement is given as an example, but an undistributed video advertisement may correspond to the estimation video advertisement. Further, a case in which a video of a live distribution service corresponds to the estimation video advertisement is given as an example, but the estimation video advertisement may be any video advertisement for which advertising effectiveness is to be estimated, and is not limited to a video of a live distribution service. For example, an online advertisement, a television advertisement, an outdoor advertisement, a movie advertisement, or another advertisement may correspond to the estimation video advertisement.

The analysis of the estimation video advertisement is processing for extracting a feature relating to the estimation video advertisement. For example, speech analysis processing, natural language processing, image analysis processing, or a combination of those corresponds to the analysis of the estimation video advertisement. The estimation video information indicates the feature extracted by the analysis of the estimation video advertisement. The estimation video information acquisition module 202 may acquire the estimation video information based on the same acquisition method as for the training video information. Thus, for details of the processing in which the estimation video information acquisition module 202 acquires the estimation video information, “training” in the description of the training video information acquisition can be read as “estimation.”

For example, the estimation video information acquisition module 202 may acquire the estimation video information acquired by executing processing similar to the natural language processing executed on the training text on the estimation text acquired by analysis of the speech in the estimation video advertisement. The processing may be at least one Of the above-mentioned sentiment analysis processing, response detection processing, explanation detection processing, or promotion detection processing. For the details of the processing as well, “training” in the description of the training video information acquisition module 102 can be read as “estimation.” The point that any natural language processing may be executed on the estimation text and the point that the natural language processing may be executed by a computer other than the estimating device 20 are also the same as for the natural language processing performed on the training text.

For Example, the estimation video information acquisition module 202 may acquire estimation video information relating to the facial expression of the estimation performer, who is a performer in the estimation video advertisement, which is acquired by analyzing the video of the estimation video advertisement. The video of the estimation video advertisement includes a plurality of frames (still images). The estimation video information acquisition module 202 acquires estimation video information by executing image analysis processing on each frame. The point that any image analysis processing may be executed on the video of the estimation video advertisement and the point that the image analysis processing may be executed by a computer other than the estimating device 20 are also the same as for the image analysis processing performed on the video of the training video advertisement.

### Estimation Module

The estimation module 203 estimates the advertising effectiveness of the estimation video advertisement based on the estimation video information and the machine learning model M. For example, the estimation module 203 inputs the estimation video information to the machine learning model M. Instead of inputting the estimation video information as it is, the estimation module 203 may execute some sort of processing such as normalization or aggregation processing, and then input the processed estimation video information to the machine learning model M. The machine learning model M calculates the feature amount of the estimation video information input to the machine learning model M based on the parameter portion adjusted by the training, and outputs an estimation result corresponding to the feature amount. The internal processing of the machine learning model M may be processing adopted in publicly-known machine learning methods.

In this embodiment, a case in which the output portion of the training data is training purchase information indicating the percentage of training viewers who make a purchase among the training viewers who view the training video advertisement is given as an example, and thus the estimation result output from the machine learning model M is also similar information. For example, the machine learning model M outputs, as the estimation result, estimation purchase information indicating the percentage of estimation viewers estimated to make a purchase among the estimation viewers who view the estimation video advertisement (percentage of estimation viewers who are expected to make a purchase, that is, purchase probability). The estimation module 203 acquires the estimation result output from the machine learning model M. The estimation module 203 may store the estimation result of the machine learning model M in the estimation database DB2.

When the training purchase information is other information as described above, the estimation purchase information is the same information as the other information. For example, the machine learning model M may output, as the estimation result, information indicating the presence or absence of a purchase by each estimation viewer, the total number of estimation viewers estimated to make the purchase, the total number of those people per unit time, or a combination of those. As another example, the machine learning model M may output, as the estimation result, information relating to the estimated sales of the product or the service introduced in the estimation video advertisement. The information relating to the sales may be the number of sales (number sold) estimated for the product or the service, the sales amount, the number of sales per unit time, the sales amount per unit time, or a combination of those.

### 3-3. Functions Implemented by Server

For example, the server 30 includes a data storage unit 300 and the distribution module 301. The data storage unit 300 is implemented by the storage unit 32. The distribution module 301 is implemented by the control unit 31.

### Data Storage Unit

The data storage unit 300 stores data required for the live distribution service. For example, the data storage unit 300 stores the video advertisement database DB3.

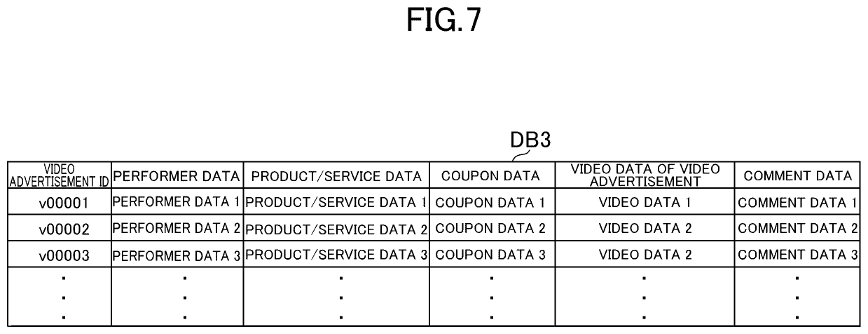

FIG. 7 is a table for showing an example of the video advertisement database DB3. The video advertisement database DB3 is a database which stores data relating to the video advertisements in the live distribution service. In this embodiment, the video advertisement for which data is stored in the video advertisement database DB3 can be at least one of a training video advertisement or an estimation video advertisement. The video advertisement for which data is stored in the video advertisement database DB3 may be used as both a training video advertisement and an estimation video advertisement.

For example, the video advertisement database DB3 stores a video advertisement ID that can identify each video advertisement, performer data relating to each performer, product/service data relating to the product or the service introduced in the video advertisement, coupon data relating to a coupon for the product or the service, video data of each video advertisement, and comment data relating to comments by the viewers. The video advertisement database DB3 may store, in addition to video advertisements currently being distributed, an archive of video advertisements distributed in the past. As another example, the video advertisement database DB3 may store data relating to a reaction stamp. A reaction stamp is a function that allows a viewer to provide a reaction by selecting at least one of a plurality of stamps (for example, hard or thumbs up) at any timing while viewing a video advertisement. A reaction stamp is an example of a response (reaction) by the user.

For example, when an operation to start distributing a new video advertisement is performed by the performer, the distribution module 301 issues a video advertisement ID for the video advertisement. The distribution module 301 stores data such as performer data in the video advertisement database DB3 in association with the video advertisement ID. The performer data may indicate any information relating to the performer, such as the account, name, gender, age, or other features of the performer, or a combination of those. The product/service data may indicate any information relating to the product or the service, such as the category of the product or the service, the title of the product or the service, an explanatory text of the product or the service, a link to a more detailed page about the product or the service, or a combination of those.

The coupon data may indicate any information relating to a coupon for the product or the service, such as a discount amount, a discount rate, a total number of coupons, a condition for using the coupon, a condition for acquiring the coupon, an acquisition status of the coupon, or a combination of those. The video data is generated by the distribution module 301 recording the video advertisement. The video data may be in any data format. The video data may show only video, and not include speech. The video data may include basic information on the video advertisement, such as playback time of the video.

The comment data is data indicating the content of the comment. For example, the comment data indicates the account of the viewer who has posted the comment, text indicating the content of the comment, the date and time of posting the comment, or a combination of those. The viewer may provide a reaction other than a comment. In this case, data indicating the reaction by the viewer is stored in the video advertisement database DB3. The video advertisement database DB3 may store data relating to the sales trend of the product or the services introduced in the video advertisement.

The data storage unit 300 can store any data. The data stored by the data storage unit 300 is not limited to the video advertisement database DB3. For example, the data storage unit 300 may store data indicating a purchase status of the product or the service introduced in each video advertisement. The data may indicate the account of the viewer who has purchased the product or the service, the number of sales of the product or the service, the sales amount, the number of sales per unit time, the sales amount per unit time, or a combination of those. Those pieces of data may be stored in the video advertisement database DB3. The video advertisement database DB3 may store data relating to viewers who have viewed the video advertisement, regardless of whether or not the viewer has posted a comment. Based on the data, information such as how many viewers have viewed the video advertisement and how long each viewer has viewed the video advertisement may be analyzed.

### Distribution Module

The distribution module 301 distributes video advertisements to viewers. The processing executed by the distribution module 301 may be similar to the processing adopted in publicly-known live distribution services. The distribution module 301 distributes a video advertisement to each of the training viewer device 50 and the estimation viewer device 70. The distribution module 301 receives comments input from each of the training viewer device 50 and the estimation viewer device 70. The distribution module 301 updates the video advertisement database DB3 based on the content of the communication to and from each of the training performer device 40, the training viewer device 50, the estimation performer device 60, and the estimation viewer device 70.

### 4. Processing Executed by Each of Learning Device and Estimating Device

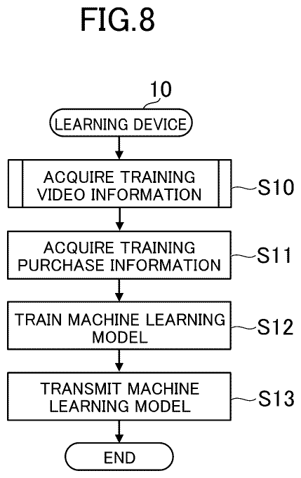

FIG. 8 is a flowchart for illustrating an example of processing executed by the learning device 10. The processing of FIG. 8 is executed by the control unit 11 operating in accordance with a program stored in the storage unit 12. It is assumed that the learning device 10 has downloaded the video data of the training video advertisement from the server 30 in advance when executing the processing of FIG. 8. As illustrated in FIG. 8, the learning device 10 acquires the training video information by analyzing a training video advertisement (Step S10).

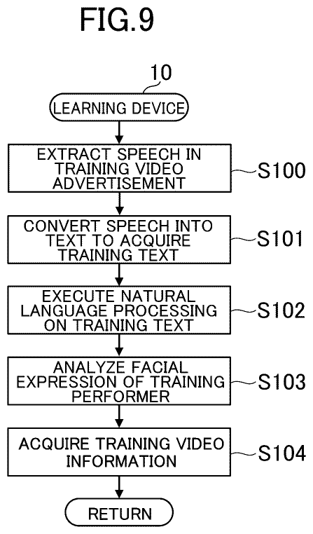

FIG. 9 is a flowchart for illustrating an example of the processing executed in Step S10. The learning device 10 extracts the speech in the training video advertisement (Step S100). The learning device 10 converts the speech into text to acquire a training text (Step S101). The learning device 10 executes natural language processing on the training text (Step S102). The learning device 10 analyzes the video of the training video advertisement, and analyzes the facial expression of the training performer (Step S103). The learning device 10 acquires the training video information based on each analysis result (Step S104). The details of each of the processing steps of from Step S100 to Step S104 are as described regarding the processing performed by the training video information acquisition module 102.

Returning to FIG. 8, the learning device 10 acquires training purchase information (Step S11). The details of the processing step of Step S11 are as described regarding the processing performed by the training purchase information acquisition module 103. It is assumed that the learning device 10 has downloaded data required for acquiring training purchase information from the server 30 in advance. The learning device 10 trains the machine learning model M based on the training video information and the training purchase information (Step S12). The details of the processing step of Step S12 are as described regarding the processing performed by the learning module 104. The learning device 10 transmits the trained machine learning model M to the estimating device 20 (Step S13), and the processing of FIG. 8 ends.

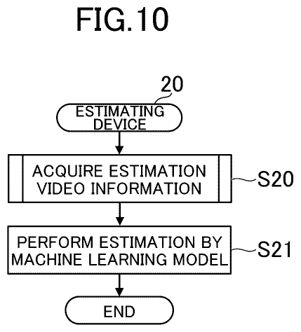

FIG. 10 is a flowchart for illustrating an example of processing executed by the estimating device 20. The processing of FIG. 10 is executed by the control unit 21 operating in accordance with a program stored in the storage unit 22. It is assumed that the estimating device 20 has downloaded the video data of the estimation video advertisement from the server 30 in advance when executing the processing of FIG. 10. As illustrated in FIG. 10, the estimating device 20 acquires the estimation video information by analyzing the estimation video advertisement (Step S20).

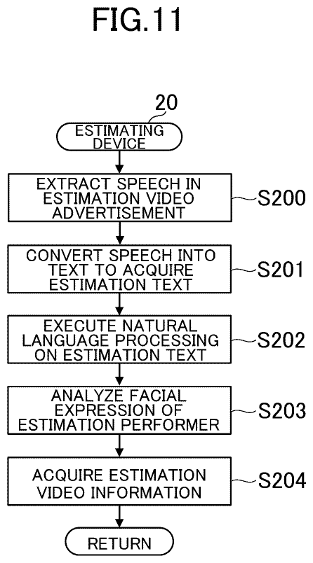

FIG. 11 is a flowchart for illustrating an example of the processing executed in Step S20. The estimating device 20 extracts the speech in the estimation video advertisement (Step S200). The estimating device 20 converts the speech into text to acquire an estimation text (Step S201). The estimating device 20 executes natural language processing on the estimation text (Step S202). The estimating device 20 analyzes the video of the estimation video advertisement, and analyzes the facial expression of the estimation performer (Step S203). The estimating device 20 acquires the estimation video information based on each analysis result (Step S204). The details of each of the processing steps of from Step S200 to Step S204 are as described regarding the processing performed by the estimation video information acquisition module 202.

Returning to FIG. 10, the estimating device 20 performs an estimation by the machine learning model M based on the estimation video information and the machine learning model M (Step S21), and the processing of FIG. 10 ends. The details of the processing step of Step S21 are as described regarding the processing performed by the estimation module 203.

### 5. Summary of Embodiment

The learning device 10 of this embodiment trains the machine learning model M based on the training video information and the training purchase information. The learning device 10 can use the machine learning model M to estimate the advertising effectiveness from the features of the estimation video advertisement by causing the machine learning model M to learn the training video information and the purchases by the training viewer, and thus a machine learning model M which estimates advertising effectiveness highly accurately can be created. For example, the learning device 10 can cause the machine learning model M to learn the features of the training video advertisement itself by causing the machine learning model M to learn training video information that has a causal relationship with advertising effectiveness. As a result, the machine learning model M can estimate the advertising effectiveness from the features of the estimation video advertisement itself, and hence the accuracy of estimating the advertising effectiveness is increased.

Further, the learning device 10 acquires the training video information acquired by executing natural language processing on the training text. The learning device 10 trains the machine learning model M for estimating the advertising effectiveness from the estimation video information acquired by executing processing similar to natural language processing on the estimation text. The learning device 10 causes the machine learning model M to learn the training video information analyzed by the natural language processing, and can then use the machine learning model M to estimate the advertising effectiveness from the features of an estimation text obtained by converting the speech in the estimation video advertisement into text. As a result, the learning device 10 can create a machine learning model M which estimates advertising effectiveness highly accurately. For example, when the learning device 10 converts speech into text, analysis based on various features becomes easier.

Further, the natural language processing is at least one of sentiment analysis processing, response detection processing, explanation detection processing, or promotion detection processing. For example, the learning device 10 can cause the machine learning model M to learn the causal relationship between the emotions of the training performer and the purchases by the training performer through sentiment analysis processing. The learning device 10 can cause the machine learning model M to learn the causal relationship between the responses by the training performer and the purchases by the training performer through response detection processing. The learning device 10 can cause the machine learning model M to learn the causal relationship between the explanation given by the training performer and the purchases by the training viewer through explanation detection processing. The learning device 10 can cause the machine learning model M to learn the causal relationship between the promotion in the training video advertisement and the purchases by the training viewer through promotion detection processing. As a result, the learning device 10 can create a machine learning model M which estimates advertising effectiveness highly accurately.

Further, the promotion detection processing is keyword detection processing for detecting at least one of a keyword relating to a price of the product or the service introduced in the training video advertisement, a keyword relating to a sales trend of the product or the service introduced in the training video advertisement, or a keyword relating to an explanation associated with the training video advertisement. The learning device 10 can use those keywords to detect a promotion which can be effectively utilized in estimating advertising effectiveness. As a result, the learning device 10 can increase the estimation accuracy of the machine learning model M for estimating the advertising effectiveness from promotions in video advertisements. For example, the learning device 10 can acquire a wider range of information by detecting a keyword regarding a coupon acquisition rate, for example, as a price-related keyword, and performing analysis that includes a parameter other than the words of the product or the service itself introduced in the video advertisement.

Further, the learning device 10 acquires the training video information relating to a facial expression of a training performer, who is a performer in the training video advertisement, the facial expression being acquired by analyzing a video of the training video advertisement. The learning device 10 trains the machine learning model M for estimating advertising effectiveness based on the estimation video information relating to the facial expression of the estimation performer, who is a performer in the estimation video advertisement, the facial expression being acquired by analyzing the video of the estimation video advertisement. The learning device 10 can cause the machine learning model M to learn the causal relationship between the facial expression of the training performer and the purchases by the training performer. As a result, the learning device 10 can create a machine learning model M which estimates advertising effectiveness highly accurately. For example, the learning device 10 can analyze individual features of the training performer that cannot be analyzed through natural language processing.

Further, the learning device 10 acquires the training purchase information relating to at least one of a presence or absence of a purchase by the training viewer or information relating to sales of the product or the service introduced in the training video advertisement. The learning device 10 trains the machine learning model M for estimating, as the advertising effectiveness, at least one of a presence or absence of a purchase by an estimation viewer who is a viewer of the estimation video advertisement or information relating to sales of the product or the service introduced in the estimation video advertisement. The learning device 10 can cause the machine learning model M to learn the causal relationship between the training video information and the at least one of a presence or absence of a purchase or information relating to sales. As a result, the learning device 10 can create a machine learning model M which estimates advertising effectiveness highly accurately. For example, unit prices vary depending on the product or the service, and hence when analysis is performed by using only the sales amount as a parameter, a product having a higher unit price may have an advantage. In this regard, the learning device 10 can create a more accurate machine learning model M by analyzing various features such as the number of sales.

The estimating device 20 of this embodiment estimates the advertising effectiveness of the estimation video advertisement based on the estimation video information and the machine learning model M. The estimating device 20 can estimate the advertising effectiveness from the features of the estimating video advertisement itself, and thus it is possible to improve the accuracy of estimating the advertising effectiveness.

### 6. Modification Examples

The present disclosure is not limited to the embodiment described above. The present disclosure can be modified as appropriate without departing from the spirit of the present disclosure.

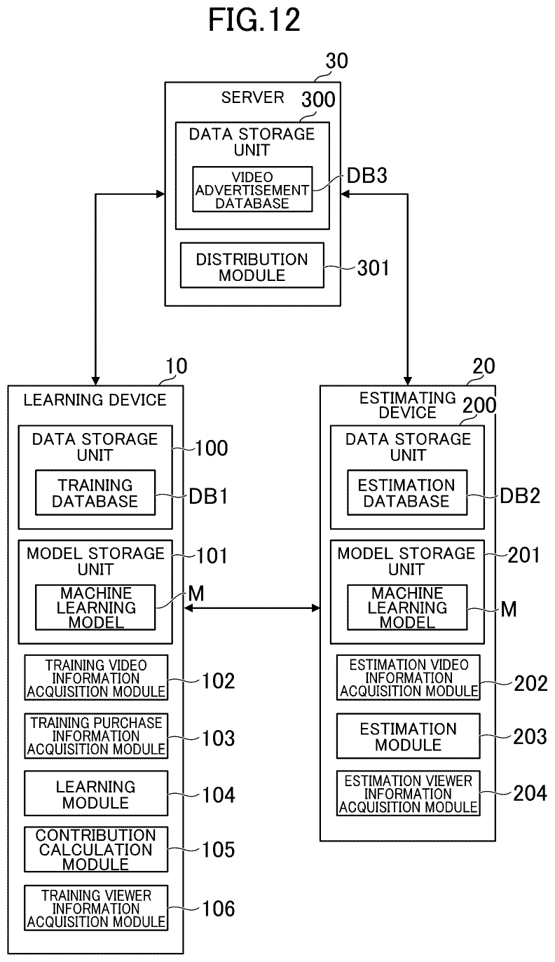

FIG. 12 is a diagram for illustrating an example of functions implemented in modification examples. As illustrated in FIG. 12, in the modification examples described below, the learning device 10 includes a contribution calculation module 105 and a training viewer information acquisition module 106. The contribution calculation module 105 and the training viewer information acquisition module 106 are implemented by the control unit 11. The estimating device 20 includes an estimation viewer information acquisition module 204. The estimation viewer information acquisition module 204 is implemented by the control unit 21.

### 6-1. Modification Example 1

For example, as described in the embodiment, the training video information acquisition module 102 may acquire a plurality of pieces of the training video information. The learning module 104 may train the machine learning model M further based on the plurality of pieces of training video information. This series of processing is as described in the embodiment. When the machine learning model M is trained by using a plurality of pieces of training video information, some of the pieces of the training video information strongly contribute to the advertising effectiveness, and some of the pieces of the training video information do not contribute much to the advertising effectiveness. Thus, a degree of contribution of each of the pieces of the training video information to the advertising effectiveness may be calculated.

The learning device 10 of Modification Example 1 includes the contribution calculation module 105. The contribution calculation module 105 calculates the degree of contribution of each of the plurality of pieces of training video information to the advertising effectiveness. The degree of contribution is the degree to which the training video information contributes to the advertising effectiveness. In other words, the degree of contribution is the degree to which the training video information contributes to the estimation by the machine learning model M. The degree of contribution may also be referred to as “importance,” “score,” “impact,” or some other name. In Modification Example 1, a case in which the degree of contribution is expressed as a numerical value between 0 and 100 is given as an example, but the degree of contribution may be expressed as a numerical value in another range, or the degree of contribution may be expressed as a character or a symbol instead of a numerical value. In Modification Example 1, when the degree of contribution is a higher value, this means that the piece of training video information contributes to the advertising effectiveness more strongly.

The method of calculating the degree of contribution may be a publicly-known method known in the field of machine learning. For example, the contribution calculation module 105 calculates the degree of contribution of each of a plurality of pieces of training video information based on a calculation method such as a random forest, gradient boosting, SHApley Additive explanations (SHAP), Local Interpretable Model-agnostic Explanations (LIME), L1 normalization, or L2 normalization. For example, in a case in which the estimation result of the machine learning model M changes significantly when the value of a certain piece of training video information changes, the contribution calculation module 105 calculates the degree of contribution of that piece of training video information so that the degree of contribution of the piece of training video information becomes higher. For example, the contribution calculation module 105 calculates the degree of contribution of the training video information such that when the increase in the numerical value indicated by the estimation result of the machine learning model M with respect to the increase in the numerical value of a piece of training video information is larger, the degree of contribution of that piece of training video information is higher.

The contribution calculation module 105 records the degree of contribution of each of the plurality of pieces of training video information in the data storage unit 100. The degree of contribution may be used for any purpose. For example, the learning device 10 may display the degree of contribution of each of the plurality of pieces of training video information on the display unit 15. The learning device 10 may output data indicating the degree of contribution of each of the plurality of pieces of training video information to another computer or an information storage medium. The learning module 104 may select at least one piece of training video information having a relatively high degree of contribution from among the plurality of pieces of training video information, and train a new machine learning model M only based on the selected at least one piece of training video information.

The learning device 10 of Modification Example 1 calculates the degree of contribution of each of the plurality of pieces of training video information to the advertising effectiveness. The learning device 10 can identify the training video information contributing to the advertising effectiveness based on the degree of contribution of each of the plurality of pieces of training video information. For example, the learning device 10 can present, to the person who creates the machine learning model M, the performer, or another person, which pieces of training video information among the plurality of pieces of training video information contribute to the advertising effectiveness. For example, the performer can create a video advertisement having a higher advertising effectiveness by referring to the degree of contribution when creating a video advertisement in the future. For example, the learning device 10 can identify which elements of the training video information used in the training of the machine learning model M are effective for advertising effectiveness based on the degree of contribution, and create a machine learning model M that can estimate advertising effectiveness more accurately.

### 6-2. Modification Example 2

For example, the machine learning model M may learn not only a feature in the training video advertisement, but also a feature of the training viewer. The learning device 10 of Modification Example 2 includes the training viewer information acquisition module 106. The training viewer information acquisition module 106 acquires training viewer information relating to the training viewer. For example, the training viewer information acquisition module 106 acquires training viewer information from the server 30. The training viewer information acquisition module may generate the training viewer information based on data acquired from the server 30. The training viewer information acquisition module 106 may generate the training viewer information based on data acquired from the training viewer device 50. It suffices that the training viewer information acquisition module 106 acquires the training viewer information of at least one training viewer, and may acquire the training viewer information of each of a plurality of training viewers.

The training viewer information is information indicating some sort of feature relating to the training viewer. For example, the training viewer information is a behavior by the training viewer, demographic information on the training viewer, or a combination of those. For example, the training viewer information acquisition module 106 may acquire training viewer information relating to at least one of an age of the training viewer, a gender of the training viewer, a purchase history of the training viewer at a shop, a training comment input by the training viewer regarding the training video advertisement, acquisition of a coupon relating to the training video advertisement by the training viewer, a viewing status of the training video advertisement by the training viewer, an access status by the training viewer, or a search by the training viewer.

Demographic information on the training viewer, such as the age and gender of the training viewer, may be stored in the data storage unit 300 of the server 30, or may be input by the training viewer when viewing the training video advertisement. The training viewer information acquisition module 106 may acquire the training viewer information by acquiring the age and the gender stored in advance in the data storage unit 300 of the server 30 or by acquiring the age and the gender input by the training viewer.

The purchase history of the training viewer at a shop is the history of online or offline purchases at the shop. The purchase history can also be referred to as “shop usage history by the training viewer.” For example, the purchase history is information on a shop used by the training viewer, information on the product or the service purchased by the training viewer, the date and time the training viewer used the shop, or a combination of those. The purchase history of the training viewer at the shop may be stored in the data storage unit 300 of the server 30, or may be stored on another computer or an information storage medium. The training viewer information acquisition module 106 may acquire the training viewer information from the data storage unit 300, the another computer, or the information storage medium by acquiring the purchase history of the training viewer at the shop.

For example, the comment data indicating a training comment is stored in the video advertisement database DB3. The training viewer information acquisition module 106 acquires the training viewer information by acquiring the training comment from the video advertisement database DB3. The training viewer information acquisition module 106 may execute natural language processing on the training comment, and acquire the training viewer information based on the execution result of the natural language processing. The natural language processing may be similar to the processing performed on the training text described in the embodiment. For example, the training viewer information acquisition module 106 may execute natural language processing such as sentiment analysis processing or response detection processing on the training comment.

For example, coupon data indicating the acquisition status of a coupon relating to the training video advertisement by the training viewer is stored in the video advertisement database DB3. The training viewer information acquisition module 106 acquires the training viewer information by acquiring the acquisition status of the coupon from the video advertisement database DB3. The acquisition status of the coupon may be the total number of coupons acquired by the training viewer, the total number of those coupons per unit time, a chronological change in the total number, or a combination of those.

For example, the viewing status of the training video advertisement by the training viewer is stored in the video advertisement database DB3. The training viewer information acquisition module 106 acquires the training viewer information by acquiring the viewing status from the video advertisement database DB3. The viewing status of the training video advertisement may be any information relating to viewing by the training viewer, such as a viewing time by the training viewer (the time the training viewer actually viewed the video advertisement out of the playback time of the video advertisement), a percentage of the viewing time with respect to the playback time, a time period during which the training viewer viewed the video advertisement, or a combination of those.

For example, the access status by the training viewer is stored in the video advertisement database DB3. The training viewer information acquisition module 106 acquires the training viewer information by acquiring the access status from the video advertisement database DB3. The access status may be the access status in relation to any page, for example, the access status in relation to a live distribution service page, or the access status in relation to an electronic commerce page. The access status may be whether or not a certain page has been accessed, the number of floors the page has been accessed, the frequency of access, the time period of access, or a combination of those.

For example, the search result by the training viewer is stored in the video advertisement database DB3. The training viewer information acquisition module 106 acquires the training viewer information by acquiring the access status from the video advertisement database DB3. The search by the training viewer may be a search in the live distribution service, e-commerce, or another service. The search by the training viewer may be based on the query input at the time of the search, the time period during which the search is executed, the behavior of the user after the search, or a combination of those.

The training viewer information may be any feature relating to the training viewer, and is not limited to the examples described above. For example, as the training viewer information, the training viewer information acquisition module 106 may acquire an elapsed time since the training viewer started using the live distribution service, the product or the service that the training viewer purchased via the live distribution service, the number of video advertisements viewed by the training viewer through the live distribution service, an annual income of the training viewer, a preference of the training viewer, or other information. The training viewer information acquisition module 106 may acquire a plurality of pieces of training viewer information.

The learning module 104 in Modification Example 2 trains, further based on the training viewer information, the machine learning model M for estimating the advertising effectiveness by further using estimation viewer information relating to the estimation viewer who is a viewer of the estimation video advertisement. For example, the learning module 104 trains the machine learning model M for estimating the advertising effectiveness by further using the estimation viewer information relating to at least one of an age of the estimation viewer, a gender of the estimation viewer, a purchase history of the estimation viewer at a shop, an estimation comment input by the estimation viewer regarding the estimation video advertisement, acquisition of a coupon relating to the estimation video advertisement by the estimation viewer, a viewing status of the estimation video advertisement by the estimation viewer, an access status by the estimation viewer, or a search by the estimation viewer. The learning module 104 may train the machine learning model M in the same manner even when other estimation viewer information is acquired.

For example, the learning module 104 generates the input portion of the training data based on the training video information and the training viewer information. Instead of directly using the training viewer information as the input portion of the training data, the learning module 104 may execute some sort of processing such as normalization or aggregation processing on the training viewer information, and use the processed training viewer information as the input portion of the training data. For example, the learning module 104 may aggregate the training video information of each of a plurality of training viewers, and use the aggregation result as the input portion of the training data. The learning module 104 may aggregate a gender ratio or the number of training viewers who have viewed the training video advertisement, and use the aggregated ratio or number of training viewers as the input portion of the training data.

As other examples, the learning module 104 may aggregate a distribution of the ages of the training viewers who have viewed the training video advertisement, and use the aggregated distribution as the input portion of the training data. The learning module 104 may aggregate the ratio or the number of training viewers who have purchased a certain product, and use the aggregated ratio number of training viewers as the input portion of the training data. Similarly, for other training viewer information as well, the learning module 104 may execute aggregation processing, for example, and then use the aggregated data as the input portion of the training data. The input portion of the training data is different from the embodiment, but the processing by which the learning module 104 causes the machine learning model M to learn the training data is the same as described in the embodiment.

The learning device 10 of Modification Example 2 trains, further based on the training viewer information, the machine learning model M for estimating the advertising effectiveness by further using estimation viewer information relating to an estimation viewer who is a viewer of the estimation video advertisement. The learning device 10 can create a machine learning model M which estimates advertising effectiveness highly accurately by causing the machine learning model M to learn not only the training video information but also the training viewer information. For example, when there is a causal relationship between a feature of the training viewer and advertising effectiveness (for example, when there is advertising effectiveness for a specific age group), the machine learning model M can estimate the advertising effectiveness corresponding to the feature of the training viewer. For example, the learning device 10 can expand the scope of learning by causing the machine learning model M to learn the features of individual training viewers that are not learnable by using training purchase information alone.

Further, the learning device 10 acquires training viewer information relating to at least one of an age of the training viewer, a gender of the training viewer, a purchase history of the training viewer at a shop, a training comment input by the training viewer regarding the training video advertisement, acquisition of a coupon relating to the training video advertisement by the training viewer, a viewing status of the training video advertisement by the training viewer, an access status by the training viewer, or a search by the training viewer. The learning device 10 trains the machine learning model M for estimating the advertising effectiveness by further using the estimation viewer information relating to the at least one of those pieces of training viewer information. The learning device 10 can create a machine learning model M which estimates advertising effectiveness highly accurately by causing the machine learning model M to learn not only the training video information but also the at least one of those pieces of training viewer information. For example, when there is a causal relationship between the at least one of those pieces of training viewer information and advertising effectiveness, the machine learning model M can estimate the advertising effectiveness corresponding to the feature of the training viewer.

### 6-3. Modification Example 3

For example, in Modification Example 2, the training viewer information acquisition module 106 may acquire the training viewer information relating to the training comment by executing, on the training comment, at least one of sentiment analysis processing for analyzing an emotion of the training viewer, comment classification processing for classifying the training comment, or keyword detection processing for detecting a keyword from the training comment.

The sentiment analysis processing may be similar to the sentiment analysis processing performed on the training text described in the embodiment. The training viewer information acquisition module 106 analyzes a range of emotions such as happiness, anger, sadness, and pleasure of the training viewer by executing sentiment analysis processing on the training comment, and acquires training viewer information indicating the analysis result. In the description of the sentiment analysis processing performed on the training text in the embodiment, “training text” may be read as “training comment” and “training performer” may be read as “training viewer.” The point that various types of sentiment analysis processing may be executed on the training comment is also the same as for the sentiment analysis processing performed on the training text.

The comment classification processing is processing for classifying the content of the training comment. The comment classification processing can use the method used when the meanings of words are classified in natural language processing. For example, the training viewer information acquisition module 106 may classify the training comment based on a rule approach of determining whether or not the training comment includes a keyword that falls within each of a plurality of classifications. As another example, the training viewer information acquisition module 106 may classify the training comment based on a machine learning approach of calculating the feature amount of the training comment and outputting the classification result. For example, in the comment classification processing, the training comment is classified as being one of positive or negative. The classification of the training comment may be some other type of classification.

The keyword detection processing is processing for detecting a keyword included in the training comment. The training viewer information acquisition module 106 determines whether or not the training comment includes a keyword stored in a dictionary database which stores price-related keywords (for example, “cheap”or “expensive”) , and detects the keyword. The training viewer information acquisition module 106 determines whether or not the training comment includes a keyword stored in a dictionary database which stores keywords relating to an impression of the product or the service (for example, “cute” or “cool”), and detects the keyword.

The learning module 104 trains the machine learning model M for estimating the advertising effectiveness by further using the estimation viewer information relating to the estimation comment acquired by executing, on the estimation comment, at least one of sentiment analysis processing for analyzing an emotion of the estimation viewer, comment classification processing for classifying the estimation comment, or keyword detection processing for detecting a keyword from the estimation comment. The learning module 104 may aggregate the execution results of the sentiment analysis processing, the comment classification processing, and the keyword detection processing, and generate the input portion of the training data based on the aggregation result (for example, 100 people made a positive comment, 50 people made a negative comments). This point is also as described in Modification Example 2.

For details of the processing performed on the estimation comment, “training” in the description of processing performed on the training comment can be read as “estimation.” For the natural language processing performed on the estimation comment as well, “training” in the description of the natural language processing performed on the training comment can be read as “estimation.” The processing performed during estimation is executed by the estimating device 20, and thus the processing performed on the estimation comment is executed by the estimating device 20.

The learning device 10 of Modification Example 3 acquires the training viewer information relating to the training comment by executing, on the training comment, at least one of sentiment analysis processing, comment classification processing, or keyword detection processing. The learning device 10 trains the machine learning model M for estimating the advertising effectiveness by further using the estimation viewer information acquired by executing, on the estimation comment, at least one of sentiment analysis processing, comment classification processing, or keyword detection processing. The learning device 10 can create a machine learning model M which estimates advertising effectiveness highly accurately by causing the machine learning model M to learn the analysis result from the at least one of sentiment analysis processing, comment classification processing, or keyword detection processing. For example, the learning device 10 can further increase the estimation accuracy of the machine learning model M by performing analysis based on information relating to a reaction by the training viewer.

### 6-4. Modification Example 4

For example, as described in the embodiment, the training video information acquisition module 102 may acquire a plurality of pieces of the training video information. As described in Modification Example 2 and Modification Example 3, the training viewer information acquisition module 106 may acquire a plurality of pieces of the training viewer information. In this case, the learning module 104 trains, based on the plurality of pieces of training video information and the plurality of pieces of training viewer information, the machine learning model M for estimating the advertising effectiveness from a plurality of pieces of the estimation video information and a plurality of pieces of the estimation viewer information. This series of processing is as described in the embodiment, Modification Example 2, and Modification Example 3.

The learning device 10 of Modification Example 4 includes the contribution calculation module 105. The contribution calculation module 105 calculates the degree of contribution of each of the plurality of pieces of training video information and each of the plurality of pieces of training viewer information to the advertising effectiveness. Among the functions of the contribution calculation module 105, the configuration for calculating the degree of contribution of each of the plurality of pieces of training video information may be the same as in Modification Example 1. The contribution calculation module 105 in Modification Example 4 calculates not only the degree of contribution of each of the plurality of pieces of training video information but also the degree of contribution of each of the plurality of pieces of training viewer information. That is, in order to analyze which pieces of training viewer information contribute to the advertising effectiveness among a plurality of pieces of training viewer information such as the emotions of the training viewer and the training comment of the training viewer, the contribution calculation module 105 calculates the degree of contribution of those pieces of training viewer information.

The meaning of “degree of contribution of the training viewer information” is the same as “degree of contribution of the training video information.” For the meaning of “degree of contribution of the training viewer information,” “video” in the description of the degree of contribution of the training video information in Modification Example 1 can be read as “viewer.” The contribution calculation module 105 may calculate the degree of contribution of the training viewer information by using a calculation method similar to the calculation method for the degree of contribution of the training video information. For the method of calculating the degree of contribution of the training viewer information, “video” in the description of the method of calculating the degree of contribution of the training video information in Modification Example 1 can be read as “viewer.” The contribution calculation module 105 in Modification Example 4 records the degree of contribution of each of the plurality of pieces of training video information and each of the plurality of pieces of training viewer information in the data storage unit 100. The point that the degree of contribution can be used for any purpose is also the same as in Modification Example 1.

The learning device 10 of Modification Example 4 calculates the degree of contribution of each of the plurality of pieces of training video information and each of the plurality of pieces of training viewer information to the advertising effectiveness. The learning device 10 can identify the training video information and the training viewer information contributing to the advertising effectiveness based on the degree of contribution of each of the plurality of pieces of training video information and each of the plurality of pieces of training viewer information. For example, the learning device 10 can present, to the person who creates the machine learning model M, the performer, or another person, which pieces of training video information and which pieces of training viewer information among the plurality of pieces of training video information and the plurality of pieces of training viewer information contribute to the advertising effectiveness. For example, the performer can create a video advertisement having a higher advertising effectiveness by referring to the degree of contribution when creating a video advertisement in the future. For example, the learning device 10 can identify which elements of the training video information and the training viewer information used in the training of the machine learning model M are effective for advertising effectiveness based on the degree of contribution, and create a machine learning model M that can estimate advertising effectiveness more accurately.

### 6-5. Modification Example 5

For example, in Modification Example 4, the learning module 104 may select at least one of the plurality of pieces of training video information or the plurality of pieces of training viewer information based on the degree of contribution of each of the plurality of pieces of training video information and the degree of contribution of each of the plurality of pieces of training viewer information, and train a new machine learning model M based on the selected at least one piece of information.

The learning module 104 selects at least one piece of training video information having a relatively high degree of contribution from among the plurality of pieces of training video information. For example, the learning module 104 selects at least one piece of training video information having a degree of contribution equal to or higher than a threshold value from among the plurality of pieces of training video information. The learning module 104 may select a predetermined number of pieces of training video information from among the plurality of pieces of training video information in descending order of degree of contribution. The learning module 104 trains a new machine learning model M by using only the selected at least one piece of training video information among the plurality of pieces of training video information.

The learning module 104 selects at least one piece of training viewer information having a relatively high degree of contribution from among the plurality of pieces of training viewer information. For example, the learning module 104 selects at least one piece of training viewer information having a degree of contribution equal to or higher than a threshold value from among the plurality of pieces of training viewer information. The learning module 104 may select a predetermined number of pieces of training viewer information from among the plurality of pieces of training viewer information in descending order of degree of contribution. The learning module 104 trains a new machine learning model M by using only the selected at least one piece of training viewer information among the plurality of pieces of training viewer information.

For example, the learning module 104 generates the input portion of the training data based on the selected at least one piece of training video information and the selected at least one piece of training viewer information. The learning module 104 trains a new machine learning model M based on those pieces of training data. Here, the training data is different, but the learning method itself may be the same as that of the old machine learning model M (machine learning model M temporarily created to calculate the degree of contribution). The old machine learning model M referred to here is the machine learning model M created by the method described in the embodiment and Modification Example 1 to Modification Example 4.

The learning device 10 of Modification Example 5 selects at least one of the plurality of pieces of training video information or the plurality of pieces of training viewer information based on the degree of contribution of each of the plurality of pieces of training video information and the degree of contribution of each of the plurality of pieces of training viewer information, and trains a new machine learning model M based on the selected at least one piece of information. As a result, the learning device 10 can reduce the number of pieces of information input to the machine learning model M during estimation, and therefore can generate a machine learning model M that can reduce the processing load during estimation. Further, training video information and training viewer information having relatively low degrees of contribution are not used to train the machine learning model M, and thus the accuracy of the machine learning model M is increased.

### 6-6. Modification Example 6

For example, the estimating device 20 may perform the estimation based on the machine learning model M generated by the method described in Modification Example 2 to Modification Example 5. In the machine learning model M in Modification Example 6, the training is performed further based on training viewer information relating to the training viewer. The machine learning model M is as described in Modification Example 2 to Modification Example 5.

The estimating device of Modification Example 6 includes the estimation viewer information acquisition module 204. The estimation viewer information acquisition module 204 acquires estimation viewer information relating to an estimation viewer who is a viewer of the estimation video advertisement. The estimation viewer information acquisition module 204 may acquire the estimation viewer information based on the same acquisition method as for the training viewer information. Thus, for the details of the processing by which the estimation viewer information acquisition module 204 acquires the estimation viewer information, “training” in the description of the training viewer information acquisition module 106 can be read as “estimation.”

For example, the estimation viewer information is a behavior by the estimation viewer, demographic information on the estimation viewer, or a combination of those. Those pieces of information may be stored in the data storage unit 300 of the server 30. The estimation viewer information acquisition module 204 may acquire the estimation viewer information relating to at least one of an age of the estimation viewer, a gender of the estimation viewer, a purchase history of the estimation viewer at a shop, an estimation comment input by the estimation viewer regarding the estimation video advertisement, acquisition of a coupon relating to the estimation video advertisement by the estimation viewer, a viewing status of the estimation video advertisement by the estimation viewer, an access status by the estimation viewer, or a search by the estimation viewer.

For example, the estimation viewer information acquisition module 204 may acquire the estimation viewer information relating to an estimation comment by executing, on the estimation comment, at least one of sentiment analysis processing for analyzing an emotion of the estimation viewer, comment classification processing for classifying the estimation comment, or keyword detection processing for detecting a keyword from the estimation comment. The estimation viewer information acquisition module 204 may acquire a plurality of pieces of estimation viewer information.

The estimation module 203 in Modification Example 6 estimates the advertising effectiveness further based on the estimation viewer information. The estimation module 203 inputs not only the estimation video information, but also the estimation viewer information, to the machine learning model M. The input to the machine learning model M is different from the embodiment, but the processing executed by the machine learning model M is the same as in the embodiment. The machine learning model M calculates the feature amount based not only on the estimation video information but also on the estimation viewer information, and outputs the estimation result corresponding to the feature amount. The estimation module 203 may aggregate the estimation viewer information, and then input the aggregation result to the machine learning model M.

The estimating device 20 of Modification Example 6 estimates the advertising effectiveness further based on the estimation viewer information. The estimating device 20 can increase the accuracy of estimating the advertising effectiveness by inputting not only the estimation video information, but also the estimation viewer information, to the machine learning model M. For example, when there is a causal relationship between a feature of the estimation viewer and the advertising effectiveness, the machine learning model M can estimate the advertising effectiveness corresponding to the feature of the estimation viewer. For example, the estimating device 20 can increase the accuracy of the estimation by causing the machine learning model M to learn the features of individual estimation viewers that cannot be estimated by using estimation purchase information alone.

### 6-7. Other Modification Examples

For example, the modification examples described above may be combined with one another.

For example, the learning device 10 and the estimating device 20 may be the same device. The functions described as being implemented by the learning device 10 may be distributed among a plurality of computers. The functions described as being implemented by the estimating device 20 may be distributed among a plurality of computers. The functions described as being implemented by the server 30 may be implemented by the learning device 10 or the estimating device 20.

### 7. Supplementary Notes

For example, the learning device may have the following configurations.
(1) A learning device, including:
   a training video information acquisition module configured to acquire training video information acquired by analyzing a training video advertisement which is a video advertisement for training;
   a training purchase information acquisition module configured to acquire training purchase information relating to a purchase by a training viewer who is a viewer of the training video advertisement; and
   a learning module configured to train, based on the training video information and the training purchase information, a machine learning model for estimating an advertising effectiveness of an estimation video advertisement, which is a video advertisement for estimation, from estimation video information acquired by analyzing the estimation video advertisement.
(2) The learning device according to Item (1),
   wherein the training video information acquisition module is configured to acquire the training video information acquired by executing natural language processing on training text acquired by analyzing speech in the training video advertisement, and
   wherein the learning module is configured to train the machine learning model for estimating the advertising effectiveness from the estimation video information acquired by executing processing similar to the natural language processing on an estimation text acquired by analyzing speech in the estimation video advertisement.
(3) The learning device according to Item (2), wherein the natural language processing is at least one of sentiment analysis processing for analyzing an emotion of a training performer who is a performer in the training video advertisement, response detection processing for detecting a response by a training performer who is a performer in the training video advertisement, explanation detection processing for detecting an explanation relating to a product or a service introduced in the training video advertisement, or promotion detection processing for detecting a promotion relating to the training video advertisement.
(4) The learning device according to Item (3), wherein the promotion detection processing is keyword detection processing for detecting at least one of a keyword relating to a price of the product or the service introduced in the training video advertisement, a keyword relating to a sales trend of the product or the service introduced in the training video advertisement, or a keyword relating to an explanation associated with the training video advertisement.
(5) The learning device according to any one of Items (1) to (4),
   wherein the training video information acquisition module is configured to acquire the training video information relating to a facial expression of a training performer who is a performer in the training video advertisement, the facial expression being acquired by analyzing a video of the training video advertisement, and
   wherein the learning module is configured to train the machine learning model for estimating the advertising effectiveness from the estimation video information relating to a facial expression of an estimation performer who is a performer in the estimation video advertisement, the facial expression being acquired by analyzing a video of the estimation video advertisement.
(6) The learning device according to any one of Items (1) to (5),
   wherein the training purchase information acquisition module is configured to acquire the training purchase information relating to at least one of a presence or absence of a purchase by the training viewer or information relating to sales of a product or a service introduced in the training video advertisement, and
   wherein the learning module is configured to train the machine learning model for estimating, as the advertising effectiveness, at least one of a presence or absence of a purchase by an estimation viewer who is a viewer of the estimation video advertisement or information relating to sales of a product or a service introduced in the estimation video advertisement.
(7) The learning device according to any one of Items (1) to (6),
   wherein the training video information acquisition module is configured to acquire a plurality of pieces of the training video information,
   wherein the learning module is configured to train the machine learning model further based on the plurality of pieces of the training video information, and
   wherein the learning device further includes a contribution calculation module configured to calculate a degree of contribution of each of the plurality of pieces of the training video information to the advertising effectiveness.
(8) The learning device according to any one of Items (1) to (7), further including a training viewer information acquisition module configured to acquire training viewer information relating to the training viewer,
   wherein the learning module is configured to train, further based on the training viewer information, the machine learning model for estimating the advertising effectiveness by further using estimation viewer information relating to an estimation viewer who is a viewer of the estimation video advertisement.
(9) The learning device according to Item (8),
   wherein the training viewer information acquisition module is configured to acquire the training viewer information relating to at least one of an age of the training viewer, a gender of the training viewer, a purchase history of the training viewer at a shop, a training comment input by the training viewer regarding the training video advertisement, acquisition of a coupon relating to the training video advertisement by the training viewer, a viewing status of the training video advertisement by the training viewer, an access status by the training viewer, or a search by the training viewer, and
   wherein the learning module is configured to train the machine learning model for estimating the advertising effectiveness by further using the estimation viewer information relating to at least one of an age of the estimation viewer, gender of the estimation viewer, a purchase history of the estimation viewer at a shop, an estimation comment input by the estimation viewer regarding the estimation video advertisement, acquisition of a coupon relating to the estimation video advertisement by the estimation viewer, a viewing status of the estimation video advertisement by the estimation viewer, an access status by the estimation viewer, or a search by the estimation viewer.
(10) The learning device according to Item (9),
   wherein the training viewer information acquisition module is configured to acquire the training viewer information relating to the training comment by executing, on the training comment, at least one of sentiment analysis processing for analyzing an emotion of the training viewer, comment classification processing for classifying the training comment, or keyword detection processing for detecting a keyword from the training comment, and
   wherein the learning module is configured to train the machine learning model for estimating the advertising effectiveness by further using the estimation viewer information relating to the estimation comment acquired by executing, on the estimation comment, at least one of sentiment analysis processing for analyzing an emotion of the estimation viewer, comment classification processing for classifying the estimation comment, or keyword detection processing for detecting a keyword from the estimation comment.
(11) the learning device according to any one of Items (8) to (10),
   wherein the training video information acquisition module is configured to acquire a plurality of pieces of the training video information,
   wherein viewer information acquisition module is configured to acquire a plurality of pieces of the training viewer information,
   wherein the learning module is configured to train, based on the plurality of pieces of the training video information and the plurality of pieces of the training viewer information, the machine learning model for estimating the advertising effectiveness from a plurality of pieces of the estimation video information and a plurality of pieces of the estimation viewer information, and
   wherein the learning device further includes a contribution calculation module configured to calculate a degree of contribution of each of the plurality of pieces of the training video information and each of the plurality of pieces of the training viewer information to the advertising effectiveness.
(12) The learning device according to Item (11), wherein the learning module is configured to select at least one of the plurality of pieces of the training video information or the plurality of pieces of the training viewer information based on the degree of contribution of each of the plurality of pieces of the training video information and the degree of contribution of each of the plurality of pieces of the training viewer information, and to train a new machine learning model based on the selected at least one of the plurality of pieces of the training video information or the plurality of pieces of the training viewer information.

The invention claimed is:

1. A learning device, comprising at least processor configured to:
acquire training video information acquired by analyzing a training video advertisement which is a video advertisement for training;
acquire training purchase information relating to a purchase by a training viewer who is a viewer of the training video advertisement; and
train, based on the training video information and the training purchase information, a machine learning model for estimating an advertising effectiveness of an estimation video advertisement, which is a video advertisement for estimation, from estimation video information acquired by analyzing the estimation video advertisement.

2. The learning device according to claim 1, wherein the at least one processor is configured to:
acquire the training video information acquired by executing natural language processing on a training text acquired by analyzing speech in the training video advertisement, and
train the machine learning model for estimating the advertising effectiveness from the estimation video information acquired by executing processing similar to the natural language processing on an estimation text acquired by analyzing speech in the estimation video advertisement.

3. The learning device according to claim 2, wherein the natural language processing comprises at least one of sentiment analysis processing for analyzing an emotion of a training performer who is a performer in the training video advertisement, response detection processing for detecting a response by a training performer who is a performer in the training video advertisement, explanation detection processing for detecting an explanation relating to a product or a service introduced in the training video advertisement, or promotion detection processing for detecting a promotion relating to the training video advertisement.

4. The learning device according to claim 3, wherein the promotion detection processing comprises keyword detection processing for detecting at least one of a keyword relating to a price of the product or the service introduced in the training video advertisement, a keyword relating to a sales trend of the product or the service introduced in the training video advertisement, or a keyword relating to an explanation associated with the training video advertisement.

5. The learning device according to claim 1, wherein the at least processor is configured to,
acquire the training video information relating to a facial expression of a training performer who is a performer in the training video advertisement, the facial expression being acquired by analyzing a video of the training video advertisement, and
train the machine learning model for estimating the advertising effectiveness from the estimation video information relating to a facial expression of an estimation performer who is a performer in the estimation video advertisement, the facial expression being acquired by analyzing a video of the estimation video advertisement.

6. The learning device according to an claim 1, wherein the at least on cesse configured to:
acquire the training purchase information relating to at least one of a presence or absence of a purchase by the training viewer or information relating to sales of a product or a service introduced in the training video advertisement, and
train the machine learning model for estimating, as advertising effectiveness, at least one of a presence or absence of a purchase by an estimation viewer who is a viewer of the estimation video advertisement or information relating to sales of a product or a service introduced in the estimation video advertisement.

7. The learning device according to claim 1, wherein the at least or processor is configured to,
acquire a plurality of pieces of the training video information,
train the machine learning model further based on the plurality of pieces of the training video information, and
calculate a degree of contribution of each of the plurality of pieces of the training video information to the advertising effectiveness.

8. The learning device according to claim 1, wherein the at least one processor is configured to, wherein the at least one processor configured to:
acquire training viewer information relating to the training viewer, and
train, further based on the training viewer information, the machine learning model for estimating the advertising effectiveness by further using estimation viewer information relating to an estimation viewer who is a viewer of the estimation video advertisement.

9. The learning device according to claim 8, wherein the at least one processor is configured to:
acquire the training viewer information relating to at least one of an age of the training viewer, a gender of the training viewer, a purchase history of the training viewer at a shop, a training comment input by the training viewer regarding the training video advertisement, acquisition of a coupon relating to the training video advertisement by the training viewer, a viewing status of the training video advertisement by the training viewer, an access status by the training viewer, or a search by the training viewer, and
train the machine learning model for estimating the advertising effectiveness by further using the estimation viewer information relating to at least one of an age of the estimation viewer, a gender of the estimation viewer, a purchase history of the estimation viewer at a shop, an estimation comment input by the estimation viewer regarding the estimation video advertisement, acquisition of a coupon relating to the estimation video advertisement by the estimation viewer, a viewing status of the estimation video advertisement by the estimation viewer, an access status by the estimation viewer, or a search by the estimation viewer.

10. The learning device according to claim 9, wherein the at least one processor is configured to:
acquire the training viewer information relating to the training comment by executing, on the training comment, at least one of sentiment analysis processing for analyzing an emotion of the training viewer, comment classification processing for classifying the training comment, or keyword detection processing for detecting a keyword from the training comment, and
train the machine learning model for estimating the advertising effectiveness by further using the estimation viewer information relating to the estimation comment acquired by executing, on the estimation comment, at least one of sentiment analysis processing for analyzing an emotion of the estimation viewer, comment classification processing for classifying the estimation comment, or keyword detection processing for detecting a keyword from the estimation comment.

11. The learning device according to a claim 8, wherein the at least one processor is configured to:
acquire a plurality of pieces of the training video information,
acquire a plurality of pieces of the training viewer information,
train, based on the plurality of pieces of the training video information and the plurality of pieces of the training viewer information, the machine learning model for estimating the advertising effectiveness from a plurality of pieces of the estimation video information and a plurality of pieces of the estimation viewer information, and
calculate a degree of contribution of each of the plurality of pieces of the training video information and each of the plurality of pieces of the training viewer information to the advertising effectiveness.

12. The learning device according to claim 11, wherein the at least one processor is configured to select at least one of the plurality of pieces of the training video information or the plurality of pieces of the training viewer information based on the degree of contribution of each of the plurality of pieces of the training video information and the degree of contribution of each of the plurality of pieces of the training viewer information, and to train a new machine learning model based on the selected at least one of the plurality of pieces of the training video information or the plurality of pieces of the training viewer information.

13. An estimating device, comprising at least one processor is configured to:
acquire estimation video information acquired by analyzing an estimation video advertisement which is a video advertisement for estimation;
store a machine learning model trained based on training video information acquired by analyzing a training video advertisement which is a video advertisement for training and training purchase information relating to a purchase by a training viewer who is a viewer of the training video advertisement; and
estimate an advertising effectiveness of the estimation video advertisement based on the estimation video information and the machine learning model.

14. The estimating device according to claim 13,
wherein the machine learning model is trained further based on training viewer information relating to the training viewer,
wherein the at least one processor is configured to;
acquire estimation viewer information relating to an estimation viewer who is a viewer of the estimation video advertisement, and
estimate the advertising effectiveness further based on the estimation viewer information.

15. A learning method, comprising:
acquiring training video information acquired by analyzing a training video advertisement which is a video advertisement for training;
acquiring training purchase information relating to a purchase by a training viewer who is a viewer of the training video advertisement; and
training, based on the training video information and the training purchase information, a machine learning model for estimating an advertising effectiveness of an estimation video advertisement, which is a video advertisement for estimation, from estimation video information acquired by analyzing the estimation video advertisement.

16. (canceled)

17. (canceled)

18. (canceled)
